(19) United States
(12) Patent Application Publication
(10) Pub. No.: US 2022/0008898 A1
(43) Pub. Date: Jan. 13, 2022

(54) CATALYSTS AND METHODS FOR DEPOLYMERIZING PLASTICS

(71) Applicant: Alliance for Sustainable Energy, LLC, Golden, CO (US)

(72) Inventors: Gregg Tyler BECKHAM, Golden, CO (US); Lucas Delano ELLIS, Boulder, CO (US)

(21) Appl. No.: 17/370,244

(22) Filed: Jul. 8, 2021

Related U.S. Application Data
(60) Provisional application No. 63/161,525, filed on Mar. 16, 2021.
(60) Provisional application No. 63/050,209, filed on Jul. 10, 2020.

(51) Int. Cl. B01J 23/42; B01J 21/04; B01J 6/00; B01J 37/04

(52) U.S. Cl. CPC B01J 23/42; B01J 37/04; B01J 6/001; B01J 21/04

(57) ABSTRACT

The present disclosure relates to a composition that includes a dehydrogenation (D) catalyst and a cross metathesis (CM) catalyst, where both catalysts are positioned on a support.

### CROSS-REFERENCE TO RELATED APPLICATIONS

This application claims priority from U.S. Provisional Patent Application Nos. 63/050,209, and 63/161,525 filed on Jul. 10, 2020 and Mar. 16, 2021, respectively, the contents of which are incorporated herein by reference in their entirety.

### CONTRACTUAL ORIGIN

This invention was made with government support under Contract No. DE-AC36-08G028308 awarded by the Department of Energy. The government has certain rights in the invention.

### BACKGROUND

Plastics were once called “the material of one thousand uses.” However, end-use is the one use, that has yet to be discovered. Nearly 60% of the 8.3 M metric tonnes of plastics that have been produced between 1950-2015 ended up in landfills or dispersed in the environment, with only 7% recycled; and the problem is getting worse. Current estimates suggest the amount of plastics ending up in land-fills or dispersed in the environment will double by 2045, with more plastic ending up in the ocean than fish by 2050 (REF). There has never been a greater need to develop value-added, or upcycling technologies to monetize the recycling of plastic wastes.

### SUMMARY

An aspect of the present disclosure is a composition that includes a dehydrogenation (D) catalyst and a cross metathesis (CM) catalyst, with both positioned on a support. In some embodiments of the present disclosure, the D catalyst may include at least one of tin, platinum, palladium, nickel, ruthenium, iridium, a chromium oxide, a gallium oxide, a vanadium oxide, a molybdenum oxide, and/or an indium oxide. In some embodiments of the present disclosure, the CM catalyst may include at least one of rhenium, molybdenum, and/or tungsten. In some embodiments of the present disclosure, the support may include at least one of a metal oxide, silicalite, and/or a zeolite. In some embodiments of the present disclosure, the metal oxide may include at least one of Al₂O₃, SiO₂, ZrO₂, CeO₂, MgO, and/or ZnO₂. In some embodiments of the present disclosure, the zeolite may include at least oner of KL, MCM-41, Beta type (including Sn, Zn, and other variants), zeolite Y (including Na and other variants), SBA-15, and/or ZSM-5. In some embodiments of the present disclosure, the D catalyst may include platinum and tin, the CM catalyst may include rhenium, and the support may include Al₂O₃. In some embodiments of the present disclosure, the composition may further include a promoter. In some embodiments of the present disclosure, the promoter may include at least one of lithium, sodium, potassium, rubidium, cesium, or gallium.

In some embodiments of the present disclosure, the support may include a first portion and a second portion, the D catalyst may be positioned on the first portion at a first concentration, the D catalyst may be positioned on the second portion at a second concentration that is less than the first concentration, the CM catalyst may be positioned on the first portion at a third concentration that is less than the first concentration, and the CM catalyst may be positioned on the second portion at a fourth concentration that is greater than the third concentration and greater than second concentration. In some embodiments of the present disclosure, the first concentration may be between about 0.1 wt % and about 15 wt %, or between about 0.5 wt % and about 5 wt %. In some embodiments of the present disclosure, the second concentration may be between about 0.1 wt % and about 20 wt %, or between about 5 wt % and about 12 wt %. In some embodiments of the present disclosure, the composition may further include HCl positioned on the support.

An aspect of the present disclosure is a method that includes contacting a mixture that includes a first hydrocarbon and a second hydrocarbon with a composition, where the first hydrocarbon has a first molecular weight, the second hydrocarbon has a second molecular weight, the first molecular weight is larger than the second molecular weight, and the contacting results in a decrease of the first molecular weight to a third molecular weight. Further, the composition includes a dehydrogenation (D) catalyst and a cross metathesis (CM) catalyst, where both catalysts are positioned on a support.

In some embodiments of the present disclosure, the contacting may be performed at a temperature between about 120° C. and about 400° C., or between about 180° C. and about 250° C. In some embodiments of the present disclosure, the contacting may be performed at a pressure between about 1 bar and about 40 bar. In some embodiments of the present disclosure, the contacting may be performed with the first hydrocarbon and the second hydrocarbon in a gas phase. In some embodiments of the present disclosure, the first molecular weight may be between about 30 Da and about 300 kDa. In some embodiments of the present disclosure, the second molecular weight may be between about 1 kDa and about 100 kDa. In some embodiments of the present disclosure, the third molecular weight may be between about 30 kDa and about 60 kDa. In some embodiments of the present disclosure, the first hydrocarbon may include at least one of a high-density polyethylene (PE), a medium density PE, a low density PE, a linear low density PE, polypropylene, and/or polysytrene.

An aspect of the present disclosure is a method that includes a first synthesizing of a first solid that includes a first catalyst on a first substrate, a second synthesizing of a second solid that includes a second catalyst on a second substrate, combining the first solid with the second solid resulting in a mixture, and heating the mixture to temperature between about 120° C. and about 400° C., where the heating results in a portion of the first catalyst transferring from the first solid to the second solid, the heating results in a portion of the second catalyst transferring from the second solid to the first solid, a first concentration of the first catalyst on the first solid is higher than a second concentration of the first catalyst on the second solid, and a third concentration of the second catalyst on the second solid is higher than a fourth concentration of the second catalyst on the first solid.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates reaction results of 5 wt. % n-eicosane (C₂₀) in n-pentane using 500 mg of 0.8% Pt 1.7% Sn/γ-Al₂O₃ as the dehydrogenation catalysts and 500 mg of 10% Re₂O₇/γ-Al₂O₃ as the olefin metathesis catalyst, as a function of time at 200° C., according to some embodiments of the present disclosure.

FIG. 2 illustrates reaction results of 5 wt. % n-eicosane (C₂₀) in n-pentane using 500 mg of 0.8% Pt 1.7% Sn/γ-Al₂O₃ as the dehydrogenation catalyst and 500 mg of 10% Re₂O₇/γ-Al₂O₃ as the olefin metathesis catalyst, as a series of different reaction temperatures for a duration of 15 hours, according to some embodiments of the present disclosure.

FIG. 3 illustrates a comparison of product distribution from reactions run at the same C₂₀ conversion in the alkane rearrangement of 5 wt. % n-eicosane (C₂₀) in n-pentane when changing the dehydrogenation catalyst between, 500 mg of 1Pt/γ-Al₂O₃ (from a chlorine precursor) or 500 mg of 2% Pd/γ-Al₂O₃ paired with 500 mg of 10% Re₂O₇/γ-Al₂O₃ as the olefin metathesis catalyst, run at 200° C. for 15 hours, according to some embodiments of the present disclosure.

FIG. 4 illustrates a distribution of linear alkane products from the alkane rearrangement of 2.5 wt. % polyethylene in n-pentane with 500 mg of 10% Re₂O₇/γ-Al₂O₃ and, either 500 mg of 0.75% Pd/γ-Al₂O₃, 1% Pd/γ-Al₂O₃, or 500 mg of 1.0% Sn & 1.5% Pt/γ-Al₂O₃, at 190° C. for 15 hours, according to some embodiments of the present disclosure.

FIG. 5 illustrates the sum off linear alkane products from the alkane rearrangement of 2.5 wt. % polyethylene in n-pentane with 500 mg of 10% Re₂O₇/γ-Al₂O₃ and, either 500 mg of 0.75% Pd/γ-Al₂O₃, 1% Pd/γ-Al₂O₃, or 500 mg of 1.0% Sn & 1.5% Pt/γ-Al₂O₃, at 190° C. for 15 hours, according to some embodiments of the present disclosure.

FIG. 6 illustrates a pretreatment process, according to some embodiments of the present disclosure. Custom ½″ stainless steel tubes were loaded with 300 mg of quartz wool, followed by 200 mg of γ-Al₂O₃, catalyst, and 200 mg of γ-Al₂O₃. The tubes were then covered in perforated aluminum foil and heated in a muffle furnace and heated at 12° C./min to 500° C. and held for 1 hour. Tubes were then rapidly transferred to a custom inerting reactor, allowing each tube to cool under UHP argon for 15 min. Tubes were then emptied into 75 mL Parr reactors, which were flushed with UHP argon during addition, and the sealing process. Reactors were then loaded onto a 5000 series 6-Well Parr Instruments reactor system.

FIG. 7 illustrates a pretreatment method (see FIG. 6) developed using (Panel a) the coupling of 1-octene in n-pentane to 7-tetradecane and ethylene, according to some embodiments of the present disclosure. Gas chromatography with a flame ionization detector (GC-FID) was utilized to monitor the residual reactant and products. (Panel b) Chromatogram of the pre-reaction mixture of 10% (g/g) 1-octene in n-pentane. (Panel c) Chromatogram of the residual reactant and products from a reaction of 250 mg of Re₂O₇/γ-Al₂O₃ at 150° C. for 1.5 hours. (Panel d) Chromatogram of the residual reactant and products from a reaction of 250 mg of Re₂O₇/γ-Al₂O₃ at 200° C. for 1.5 hours. Liquid samples were analyzed by injection on a 6850 Agilent Gas Chromatograph with a HP-5MS column (30 m×0.250 mm×0.25 μm) with a temperature ramp method 50° C. (hold 1 min), 15° C./min to 180° C. (hold 1 min), ramp 20° C./min to 325° C. (hold 6 min), with a FID. Product identities were confirmed with GC-MS. *Estimated conversion (FIDarea/FIDarea).

FIG. 8 illustrates a comparison of the product yield (g/g) and n-eicosane conversion (g/g) for 5% (g/g) n-eicosane in n-pentane using two different dehydrogenation catalysts, either 500 mg of 5% Pt/γ-Al₂O₃ (commercial) or 500 mg 0.8% Pt/γ-Al₂O₃ (synthesized), in an 1:1 physical mixture with 500 mg of Re₂O₇/γ-Al₂O₃, according to some embodiments of the present disclosure. The reaction was performed at 200° C. for a duration of 15 hours. Data are shown as the average of reaction duplicates with error bars representing ±half the range of two measurements.

FIG. 9 illustrates the conversion of 5% (g/g) n-eicosane in n-pentane using 500 mg of Re₂O₇/γ-Al₂O₃, 500 mg Pt/γ-Al₂O₃, 500 mg SnPt/γ-Al₂O₃, Pt/γ-Al₂O₃ & 500 mg Re₂O₇/γ- Al₂O₃, or 500 mg SnPt/γ-Al₂O₃ & 500 mg Re₂O₇/γ-Al₂O₃ at 200° C. for 15 hours, according to some embodiments of the present disclosure. Data are shown as the average of reaction duplicates with error bars representing ±half the range of two measurements.

FIG. 10 illustrates a comparison of reaction results of 5 wt. % n-eicosane (Cm) in n-pentane when changing the dehydrogenation catalyst between, 500 mg of 0.8% Pt 1.7% Sn/γ-Al₂O₃, 500 mg of 5% Pt/γ-Al₂O₃, or 500 mg of 1% Pt/γ-Al₂O₃ (using a nitrogen precursor), paired with 500 mg of 10% Re₂O₇/γ-Al₂O₃ as the olefin metathesis catalyst, run at 200° C. for 15 hours, according to some embodiments of the present disclosure.

FIG. 11 illustrates an image of a 1:1 physical mixture of SnPt/γ-Al₂O₃ and Re₂O₇/γ-Al₂O₃ (Panel a) before and (Panel b) after reaction with n-pentane only for a duration of 15 hours at 200° C., according to some embodiments of the present disclosure.

FIG. 12 illustrates a mass balance of the products and residual C20 substrate using 500 mg Re₂O₇/γ-Al₂O₃ and either 500 mg SnPt/γ-Al₂O₃ or Pt/γ-Al₂O₃, according to some embodiments of the present disclosure. The reaction was run at 200° C. for 15 hours with 5% (g/g) n-eicosane (C20) in n-pentane. Data shown as the average of reaction duplicates.

FIG. 13 illustrates the conversion of 5% (g/g) n-eicosane (C20) in n-pentane with 750 mg of SnPt/γ-Al₂O₃ and 750 mg of Re₂O₇/γ-Al₂O₃ at 200° C. for 15 hours, according to some embodiments of the present disclosure. Pretreatment was performed as a physical mixture of both catalysts in a single pretreatment tube (mixed) or in two separate pretreatment tubes (separate). Data are shown as an average of reaction triplicate (mixed) and quadruplicate (separate) with error bars shown as standard deviation.

FIG. 14 illustrates scanning transmission electron microscopy images with energy dispersive X-ray spectroscopy (STEM-EDS) atomic percent maps of a 1:1 physical mixture of Re₂O₇/γ-Al₂O₃ and SnPt/γ-Al₂O₃, after the typical pretreatment procedure (see FIG. 6). When pretreated separately, no particles were found to have Re, Pt, and Sn. However, after pretreatment, six out of eight particles analyzed contained Re, Pt, and Sn on a single support, while the remaining two contained Sn and Re.

FIG. 15 illustrates energy dispersive x-ray spectra for a 1:1 physical mixture of Re2O7/γ-Al2O3 and SnPt/γ-Al2O3, after the typical pretreatment procedure (see FIG. 6), C=Carbon, O=Oxygen, Al=Aluminum, Re=Rhenium, Pt=platinum, Cl=chlorine, and Sn=tin, according to some embodiments of the present disclosure. The powder samples were dispersed on an ultrathin carbon film on lacey carbon support film TEM grids.

FIG. 16 illustrates the conversion of 5% (g/g) n-eicosane in n-pentane performed at 200° C. for a duration of 15 hours with the following catalysts, A=500 mg of Re₂O₇ deposited on SnPt/γ-Al₂O₃, B=500 mg of SnPt/γ-Al₂O₃ deposited on Re₂O₇/γ-Al₂O₃, Al₂O₃=500 mg of additional γ-Al₂O₃, Re=500 mg of additional Re₂O₇/γ-Al₂O₃, and SnPt=500 mg of additional SnPt/γ-Al₂O₃, according to some embodiments of the present disclosure. Reactions were run in duplicate, with the error bars shown as the half range; *reactions were run in triplicate, with the error shown as standard deviation.

FIG. 17 illustrates: Panel (a) The molecular weight distribution of the native high density PE feedstock (SRM-1475) and post reaction solids and Panel (b) the product yield of the distribution of alkane products from the depolymerization of 130 mg of SRM-1475 PE feedstock in n-pentane, according to some embodiments of the present disclosure. The product distribution is the average of three reaction replicates, and the error bars represent the standard deviation.

FIG. 18 illustrates the distribution of linear alkane products after depolymerization of a 250 mg of SRM-1475 feedstock (PE, Mw=54.1±2 kDa) in n-pentane, with a physical mixture of two catalysts, 500 mg Re₂O₇/γ-Al₂O₃ and 500 mg SnPt/γ-Al₂O₃, according to some embodiments of the present disclosure. Reactions were performed at reaction temperatures of 180° C., 190° C., or 200° C. for 15 hours. Data are presented as an average of reaction duplicates with error bars shown as ±half the range of two measurements.

FIG. 19 illustrates the mass balance of the products and estimated PE recovered, according to some embodiments of the present disclosure. Estimated PE recovery was based on the reduction in molecular weight and the starting mass of feedstock. Reaction was run with 500 mg SnPt/γ-Al₂O₃ and 500 mg Re₂O₇/γ-Al₂O₃, at 200° C. for a duration of 15 hours with 130 mg of SRM-1475 feedstock (PE, Mw=54.1±2 kDa). Data are shown as the average of reaction triplicates.

FIG. 20 illustrates the distribution of linear alkane products after depolymerization of a 130 mg of a SRM-1475 feedstock (PE, Mw=54.1±2 kDa) in n-pentane or n-pentane only, with a physical mixture of two catalysts, 750 mg Re₂O₇/γ-Al₂O₃ and 750 mg SnPt/γ-Al₂O₃, according to some embodiments of the present disclosure. Reactions were performed at 200° C. for a duration of 15 hours. Data is presented as an average of reaction triplicates with error bars shown as standard deviation.

FIG. 21 illustrates the conversion of C₂₀ (n-eicosane) and the measured linear alkane products in the alkane rearrangement of 5 wt. % n-eicosane in n-pentane with 500 mg of 1% Pd/γ-Al₂O₃ and either 10% Re₂O₇/γ-Al₂O₃, 8% Mo+1% Na/SiO₂—Al₂O₃, 8% Mo+1% K/SiO₂—Al₂O₃, or 4% Mo/SiO₂ at 200° C. for 15 hours, according to some embodiments of the present disclosure.

FIG. 22 illustrates a comparison of an exemplary method and diversity of products that may be produced from TDOCM using co-reactants or alternative solvents, according to some embodiments of the present disclosure.

FIG. 23 illustrates a comparison of reaction results of 5 wt. % n-eicosane (Cm) in n-pentane when changing the dehydrogenation catalyst between, 500 mg of 0.8% Pt 1.7% Sn/γ-Al₂O₃, 500 mg of 5% Pt/γ-Al₂O₃, 500 mg of 1% Pt/γ-Al₂O₃ (using a chlorine precursor), 500 mg of 1% Pt 1.5% Sn/γ-Al₂O₃, or 500 mg of 1% Pd/γ-Al₂O₃, paired with 500 mg of 10% Re₂O₇/γ-Al₂O₃ as the olefin metathesis catalyst, run at 200° C. for 15 hours, according to some embodiments of the present disclosure.

FIG. 24 illustrates a comparison of reaction rates in the alkane rearrangement of results of 5 wt. % n-eicosane (C₂₀) in n-pentane when changing the dehydrogenation catalyst between, SnPt, Pd, or Pt, paired with 500 mg of 10% Re₂O₇/γ-Al₂O₃ as the olefin metathesis catalyst, run at 200° C. for 15 hours, according to some embodiments of the present disclosure.

### DETAILED DESCRIPTION

The present disclosure may address one or more of the problems and deficiencies of the prior art discussed above. However, it is contemplated that some embodiments as disclosed herein may prove useful in addressing other problems and deficiencies in a number of technical areas. Therefore, the embodiments described herein should not necessarily be construed as limited to addressing any of the particular problems or deficiencies discussed herein.

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to a catalytic system capable of rearranging alkanes, including long chained alkanes such as polymers and plastics. As shown herein, by leveraging varying compositions of alkane solutions, a low molecular weight compound such as n-pentane and a high molecular weight compound such as high-density polyethylene (HDPE), the high molecular weight compound can be depolymerized to short alkanes at temperatures below about 200° C. In some embodiments of the present disclosure, this deconstruction of plastic may be accomplished utilizing a catalytic system composed of two heterogeneous catalysts: a dehydrogenation (D) catalyst and olefin cross metathesis (CM) catalyst. As described herein, numerous combinations of various elements were evaluated to maximize the synergy of this catalytic system, such as at least one of platinum, tin, palladium, rhenium, and/or molybdenum. Among other things, this work identifies formulations of heterogeneous catalysts, that are easily recoverable, highly active, and capable of reacting gaseous mixtures (previously very difficult to achieve with homogeneous organometallic catalysts) for the deconstruction of various plastics.

As shown herein, “tandem dehydrogenation and olefin cross metathesis” (abbreviated herein as TDOCM) technologies are capable of depolymerizing, among other molecules, PE to a distribution of alkane products. TDOCM is an example of an olefin-intermediate process (OIP) (Panel (a) of Scheme 1), which utilizes a highly active catalytic reaction coupled with an equilibrium-limited process of C—H dehydrogenation to drive the reaction.

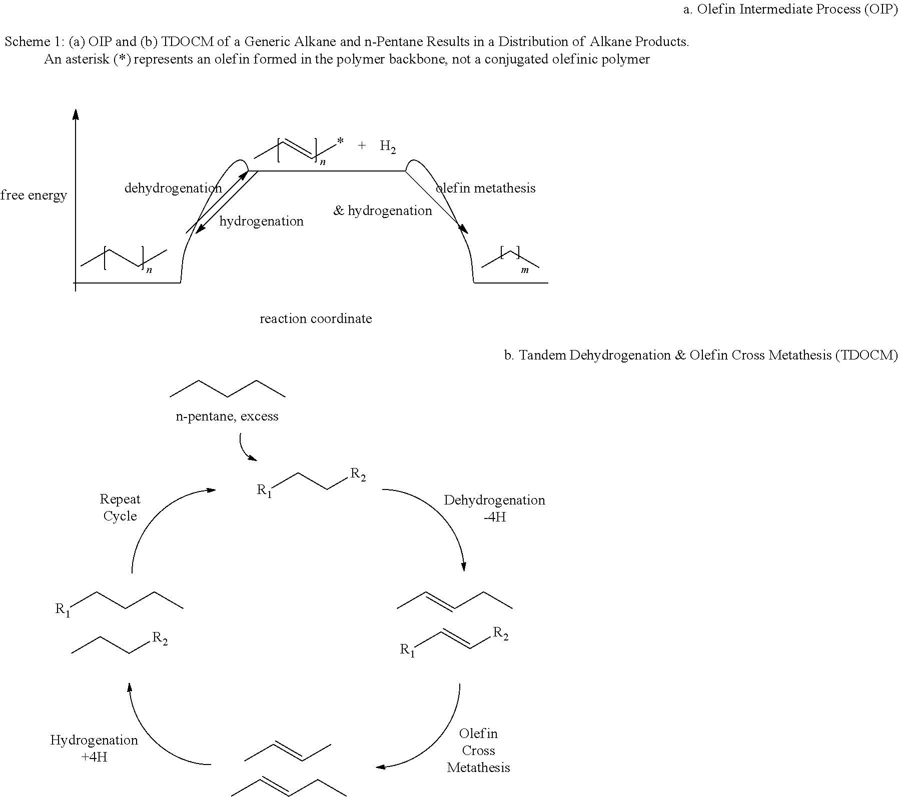

The present disclosure generally relates to the processes illustrated in Scheme 1 and catalysts and/or catalyst compositions that include a dehydrogenation (D) catalyst and a cross metathesis (CM) catalyst positioned on a support to achieve it. In some embodiments of the present disclosure, a D catalyst may include at least one of tin, platinum, palladium, nickel, ruthenium, iridium, a chromium oxide, a gallium oxide, a vanadium oxide, a molybdenum oxide, and/or an indium oxide and a CM catalyst may include at least one of rhenium, molybdenum, and/or tungsten. In some embodiments of the present disclosure, a support may include at least one of a metal oxide, silicalite, and/or a zeolite, with examples of metal oxides including at least one of Al₂O₃, SiO₂, ZrO₂, CeO₂, MgO, and/or ZnO₂, and examples of zeolites including at least one of KL, MCM-41, Beta type (including Sn, Zn, and other variants), zeolite Y (including Na and other variants), SBA-15, and/or ZSM-5. In some embodiments of the present disclosure, a D catalyst may include platinum and tin, and the CM catalyst may include rhenium, with both positioned on a support of Al₂O₃. In some embodiments of the present disclosure, a catalyst may further include a promoter, such as at least one of lithium, sodium, potassium, rubidium, cesium, and/or gallium.

In some embodiments of the present disclosure, a catalyst and/or a catalyst system may include a support having a first portion and a second portion, with the D catalyst positioned on the first portion at a first concentration and positioned on the second portion at a second concentration that is less than the first concentration. Further, the CM catalyst may be positioned on the first portion at a third concentration that is less than the first concentration and positioned on the second portion at a fourth concentration that is greater than the third concentration and greater than the second concentration. In some embodiments of the present disclosure, the first concentration may be between about 0.1 wt % and about 15 wt %, or between about 0.5 wt % and about 5 wt %. In some embodiments of the present disclosure, the second concentration is between about 0.1 wt % and about 20 wt %, or between about 5 wt % and about 12 wt %. In some embodiments of the present disclosure, a catalyst and/or a catalyst system may further include HCl positioned on the support.

As described herein, such catalysts and/or catalyst systems may be utilized for the deconstruction of polymers by contacting a mixture comprising a first hydrocarbon (e.g., a polymer to be deconstructed) and a second hydrocarbon with the catalyst and/or catalyst system. The first hydrocarbon may be characterized by a first molecular weight, and the second hydrocarbon by a second molecular weight that is less than the first molecular weight, where the contacting results in the deconstruction of higher molecular weight hydrocarbon. In some embodiments of the present disclosure, the contacting may be performed at a temperature between about 120° C. and about 400° C., or between about 180° C. and about 250° C. In some embodiments of the present disclosure, the contacting may be performed at a pressure between about 1 bar and about 40 bar of additional gas. In some embodiments of the present disclosure, the contacting may be performed with the first hydrocarbon and the second hydrocarbon in a gas phase. In some embodiments of the present disclosure, the first molecular weight may be between about 30 Da and about 300 kDa. In some embodiments of the present disclosure, the second molecular weight may be between about 1 kDa and about 100 kDa. In some embodiments of the present disclosure, the third molecular weight may be between about 30 kDa and about 60 kDa. In some embodiments of the present disclosure, the first hydrocarbon may include at least one of a high density polyethylene (PE), a medium density PE, a low density PE, a linear low density PE, polypropylene, and/or polysytrene.

The present disclosure also relates to methods for synthesizing the catalysts and/or catalyst systems described herein. Such methods may include a first synthesizing of a first solid that includes a first catalyst on a first substrate, a second synthesizing of a second solid that includes a second catalyst on a second substrate, and a combining of the first solid with the second solid resulting in a mixture. The mixture may then be exposed to a heating of the mixture to a temperature between 120-400° C., where the heating results in a portion of the first catalyst transferring from the first solid to the second solid, the heating results in a portion of the second catalyst transferring from the second solid to the first solid, a first concentration of the first catalyst on the first solid is higher than a second concentration of the first catalyst on the second solid, and a third concentration of the second catalyst on the second solid is higher than a fourth concentration of the second catalyst on the first solid.

As shown herein, in some embodiments of the current disclosure, a catalyst for TDOCM may include at least one of Re/Al₂O₃, Pt/Al₂O₃, SnPt/Al₂O₃, Pd/Al₂O₃, and/or Mo/Al₂O₃. As defined herein, the notation M/Al₂O₃ refers to a metallic metal (M) positioned as a particulate (e.g., nanoparticles) on a surface of an alumina substrate. As described herein, a variety of temperatures, durations, and pretreatment apparati were studied, using a model system for olefin metathesis of 1-octene to 7-tetradecene (i.e., second hydrocarbon) and ethylene (i.e., first hydrocarbon). The starting TDOCM catalyst composition was Re/Al₂O₃ with a rhenium loading of about 8 wt % relative to the total weight of the catalyst. Dual catalyst, a mixture of the D and CM catalyst, performance was first tested for the combined dehydrogenation and olefin cross metathesis in the alkane rearrangement of n-eicosane (C₂₀) in a n-pentane (C₅) solvent. A physical mixture of synthesized 8% Re/Al₂O₃ (CM catalyst) and 5% Pt/Al₂O₃ (Sigma-Aldrich) (D catalyst) was tested first. This system was catalytically active, with a C₂₀ conversion of 10.8% in about 15 hours, at about 200° C. SnPt/Al₂O₃ (D catalyst) was tested next, since Sn can act as a dehydrogenation promotor for Pt, partly due to a reduced overall deactivation rate. The SnPt catalyst demonstrated a significant improvement in overall activity and an over 5-fold higher rate of C₂₀ disappearance per reactive metal utilized (by mass). The measured conversion of C₂₀ with the SnPt catalyst (D) was 38% in about 15 hours, at about 200° C. Since a simple change in the dehydrogenation catalyst, keeping the metathesis catalyst consistent, resulted in a rate enhancement of nearly 5-fold, this suggests the limiting reaction of this tandem process is C—H activation to the olefin intermediate and not cross metathesis.

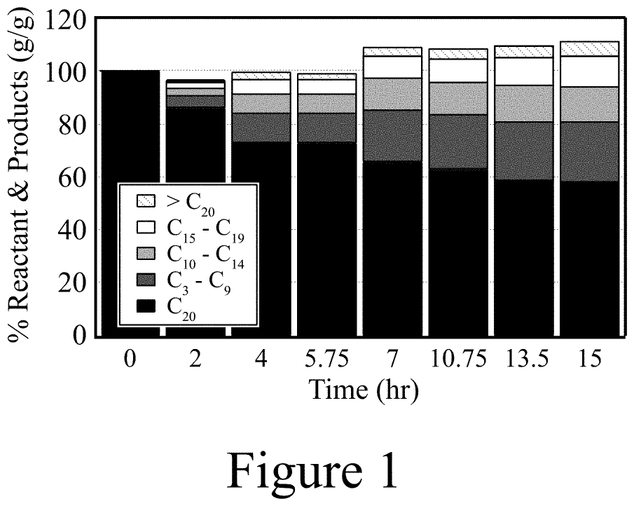

The products from this exemplary reaction a physical mixture of SnPt/Al₂O₃ and Re/Al₂O₃ resulted in a distribution of linear alkanes from C₃ to C₂₀₊ (see FIG. 1). The catalysts studied were 500 mg of 1.7% Sn 0.8% Pt/γ-Al₂O₃ and 500 mg of 8% Re/γ-Al₂O₃ (also written as 10% Re₂O₇/γ-Al₂O₃), the reaction was run at 200° C. with a 5 wt. % loading of n-eicosane (C20) in n-pentane. Ignoring the residual reactant, the distribution of the products is centred around the solvent, n-pentane, with the largest measured products being n-hexane, n-butane, and n-heptane, respectively. This analysis measured the recovered alkanes in the liquid phase. The gas phase composition of alkanes in the headspace was also analyzed after quenching the batch reactors in an ice bath, and no alkanes other than n-pentane were detected.

Interestingly, the reaction performance for the catalyst system where the D catalyst and the CM catalyst were pretreated separately versus pretreating a mixture of the two catalysts resulted in different reaction performances. The catalysts that were mixed during pretreatment had a higher conversion compared to the catalysts that were separate during pretreatment (i.e., each catalyst treated separately and later combined). STEM-EDS mapping of the mixed system demonstrated that elements were exchanging between supports at these pretreatment conditions, as evidence by the Sn, Pt, and Re found on multiple single particles of alumina. This suggests a synergy between the catalyst elements (D and CM) and/or their sites for this chemistry. To determine whether a single supported catalyst could perform as well as a physical mixture of the two catalysts, two different rhenium (CM) and tin-plantum (D) catalysts were synthesized through sequential incipient wetness methods (Re on SnPt and SnPt on Re). Both of the resultant catalysts were capable of producing linear alkane products from n-pentane and n-eicosane, but with reduced conversion compared to a physical mixture of the two catalysts, at the same loadings of reactive metals and reaction conditions. This suggests that the metal support interaction is important for at least one of the two chemistries.

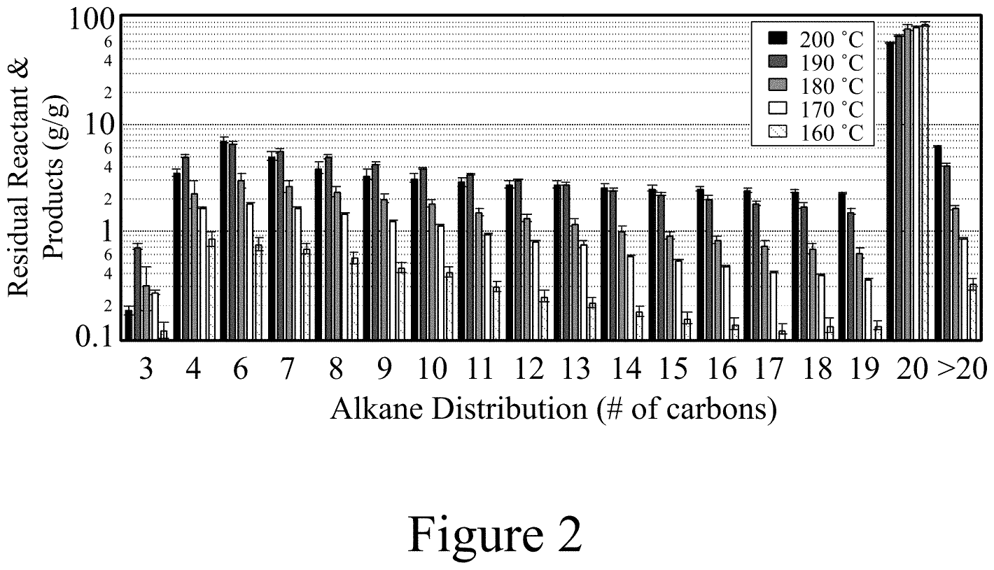

Considering the rhenium cross metathesis catalyst is a single site (i.e., on the atomic scale), and has significant differences in performance when utilizing alumina versus silica, the cross metathesis catalyst is likely the reason for the poor performance of the bi-functional catalyst. This, however, does not explain the apparent synergy when a physical mixture of the dehydrogenation catalyst and cross metathesis catalyst is pretreated together. Since elements are exchanging, as measured by STEM-EDS, it was determined that the elements are occupying the same support. In the case of dehydrogenation catalysts, rhenium may be a promotor, and may enhance dehydrogenation activity. Additionally, tin may be a promotor for rhenium metathesis catalysts. Therefore, the relatively minor enhancement in performance by mixing the catalysts together before pretreatment is likely due to low concentration dopant effects of the elements Re on the dehydrogenation catalyst and/or Sn on the cross metathesis catalyst, and not likely from the physical proximity of the two catalytic sites. FIG. 2 illustrates the response of the same system tested to produce FIG. 1, but at different temperatures (0.8% Pt 1.7% Sn/Al₂O₃ and 10% Re₂O₇/Al₂O₃, catalyst loadings (500 mg each), solvent (n-pentane), and eicosane loadings (5 wt %)).

Using six reactors in a time-series, tandem dehydrogenation and olefin cross metathesis was performed of n-pentane and n-eicosane with SnPt/Al₂O₃ (D catalyst) and Re/Al₂O₃ (CM catalyst). At about 200° C., the reaction appeared to decay in activity, approaching zero activity after about 15 hours on-stream. It is possible this is due to deactivation of either catalyst, since the dehydrogenation catalyst likely deactivates over time and unit operations are typically designed to allow catalyst regeneration steps. However, it is also possible the single-sites of the rhenium olefin metathesis catalyst were deactivating. Regardless, the same distribution of linear alkanes was recovered from the n-eicosane reactant. The total recovered linear alkane products was greater than the consumed n-eicosane reactant. This is reasonable, since the solvent is participating in the chemistry. Thus, a mass balance of products and residual reactants was greater than unity, since some of the carbon from the products comes from the solvent itself.

This catalyst system was then deployed for the depolymerization of a polyethylene (PE) with a molecular weight of about 59.6 kDa. Table 1 summarizes the distribution of measured products and the reduction in molecular weight at about 200° C. for about 15 hours. The majority of products were centered around the solvent, suggesting there were significant solvent/solvent reactions or processive reactions at the terminus of the PE molecule. The yield of the recovered products in the liquid phase was 98%. However, the residual polymer had a molecular weight of 25% of the starting material. This suggests that the overall carbon balance of products is above unity.

TABLE 1
Distribution of alkane products from the
depolymerization of PE in n-pentane. Four
reactors were run with 750 mg of 1.7% Sn
0.8% Pt/Al₂O₃ D catalyst and
750 mg of 8% Re/Al₂O₃ CM catalyst
at 200° C. for 15 hours, with 130 mg of
a PE feedstock (M_{w} = 59.6 kDa). Liquid
phase analysis is the average and standard
deviation for four reactors run in parallel.
The molecular weight of the residual polymer
is the average and half range of two replicates,
each sample a mixture of two reactors.

| C₃-C₇ | | C₈ & above | | Residual PE |
|---|---|---|---|---|
| Alkane | | Alkane | | Molecular |
| Recovery | Yield | Recovery | Yield | Weight |
| (mg) | (mg/mg) | (mg) | (mg/mg) | (kDa) |
| 66 ± 10 | 51% ± 6% | 61 ± 9 | 47% ± 6% | 15.6 ± 0.4 |

In additional experiments to test the concept depolymerizing relatively large molecules with a solvent, other heterogeneous dehydrogenation catalyst and olefin metathesis catalyst systems were tested on a large alkane (e.g., n-eicosane (C₂₀) or polyethylene) using a smaller alkane solvent (n-pentane). First a model system of the alkane rearrangement of n-eicosane in n-pentane was tested, which provides for more simplistic and rapid analytics as compared with polyethylene feedstocks. Alkane rearrangement of n-eicosane in n-pentane using either 5% Pt/γ-Al₂O₃ or 1.7% Sn 0.8% Pt/γ-Al₂O₃ and 10% Re₂O₇/γ-Al₂O₃, for about 15 hours at about 200° C., resulted in a C₂₀ conversion of 6.3%±0.8% and 41.6%±0.4%, respectively.

Next, this system was utilized to depolymerize a standard reference material (SRM) issued by the National Institute for Standards and Technology for linear polyethylene, SRM-1475. The total yield (g/g) of recovered alkanes in the liquid phase from the 130 mg loading of PE was 99.6%. However, the residual polymer had a molecular weight that was 26% of the starting material. This suggests the overall carbon balance of products was well above unity, which is feasible since the solvent was participating in the chemistry. In a control reaction with no polymer and only solvent and catalyst present, no alkanes longer than C₁₃ were measured, suggesting larger products were derived from the polymer.

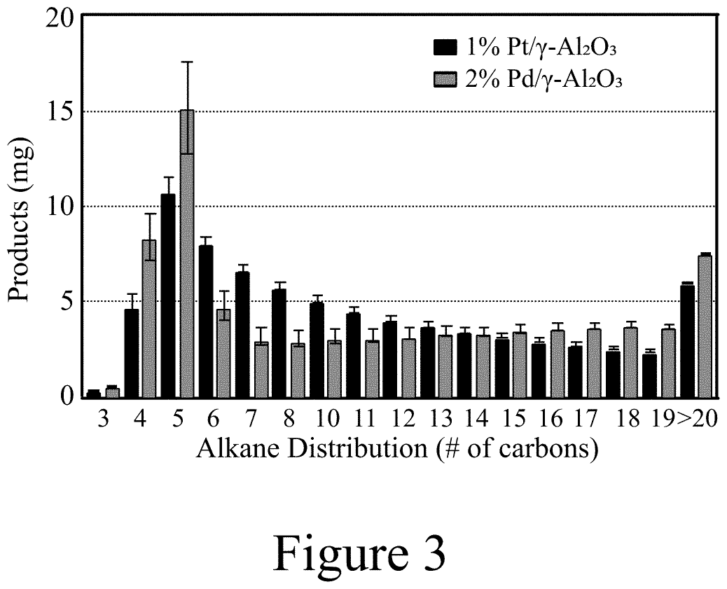

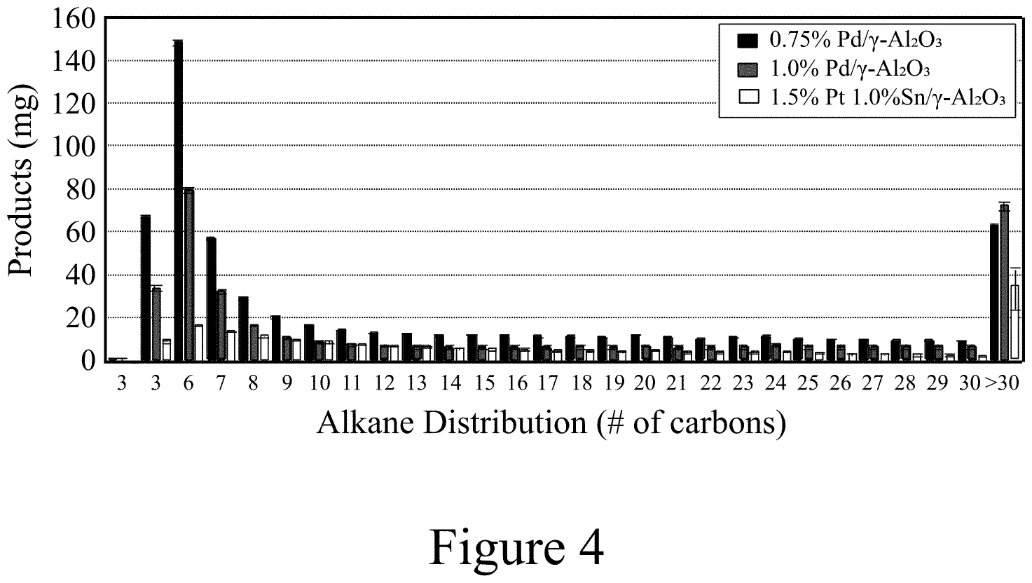

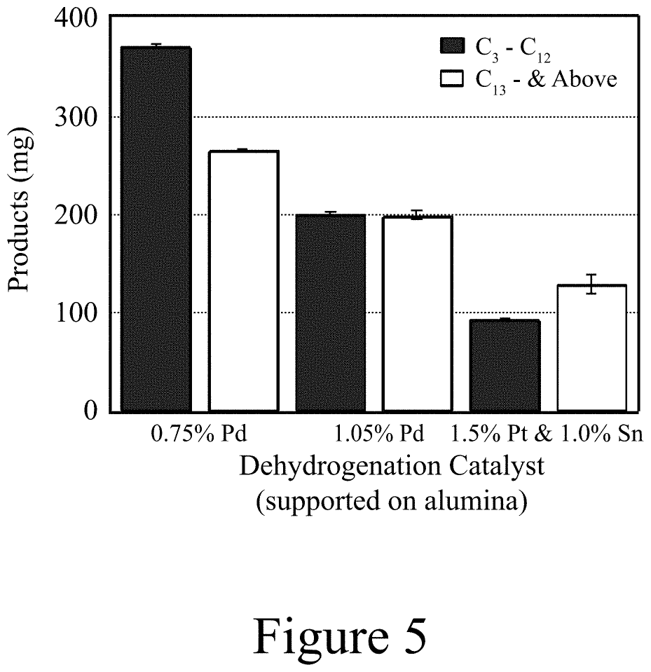

In addition, experiments identified a series of catalysts (i.e., Pd/γ-Al₂O₃, SnPt/γ-Al₂O₃, Mo/SiO₂) capable of performing “tandem dehydrogenation and olefin cross metathesis” (TDOCM) with activities that were 2× higher than the best performer represented in FIG. 3. These catalysts were applied to real PE feedstocks and demonstrated significantly enhanced yields of linear alkanes. Molecular weights and molecular weight measurements are in progress. Additionally, differences in product selectivity from differing dehydrogenation catalysts were identified. FIG. 3 illustrates the distribution of linear alkane products from using either 500 mg of 2% Pd/γ-Al₂O₃ or 1% Pt/γ-Al₂O₃ paired with 500 mg of 10% Re₂O₇/γ-Al₂O₃ in the conversion of 5 wt. % n-eicosane in n-pentane at about 200° C. for about 15 hours. Thus, process configurations or catalyst selection will provide differences in product distributions, allowing for designer products to be obtained from waste polyethylene. As seen in FIG. 3, Pd appears to give higher selectivity toward small molecular weight products, like C₆ and C₄, as compared with Pt. This effect is also true when we apply a similar set of catalysts to a polyethylene feedstock, as seen in FIG. 4. FIG. 5 illustrates a higher recovery of products less than C₁₃ for the Pd catalysts as compared to a SnPt catalyst, at the same total catalyst loading.

To further support the concepts described above, additional studies were completed on another fully heterogeneous catalyst system for PE deconstruction via tandem dehydrogenation (Pt/γ-Al₂O₃, SnPt/γ-Al₂O₃) and olefin metathesis (Re₂O₇/γ-Al₂O₃). Nonoxidative alkane dehydrogenation is an equilibrium-limited reaction that is typically performed at temperatures well above 400° C. and low pressures to achieve high alkane conversions, while the active sites of the Re-based heterogeneous olefin metathesis catalysts can be unstable above 100° C. Thus, a challenge for this system is how to kinetically couple both reactions such that the system features both high activity and stability.

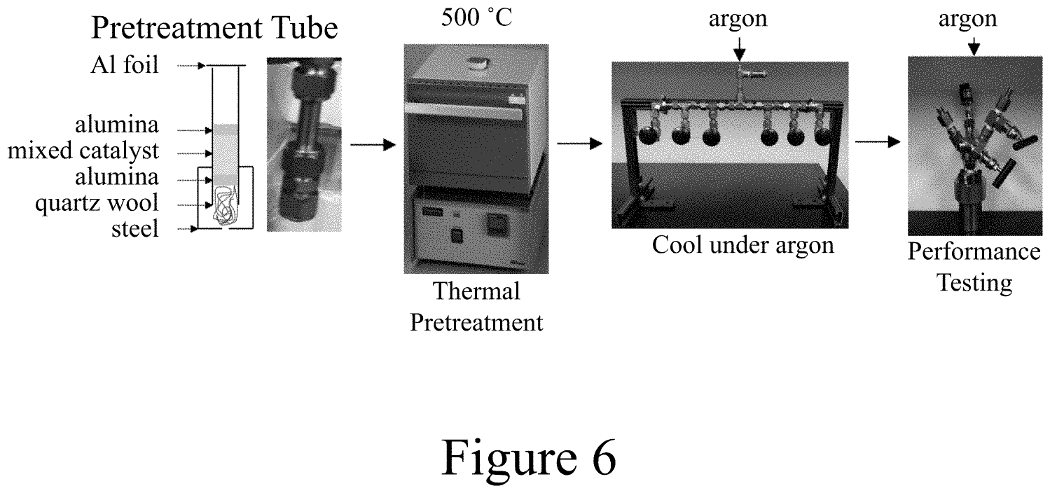

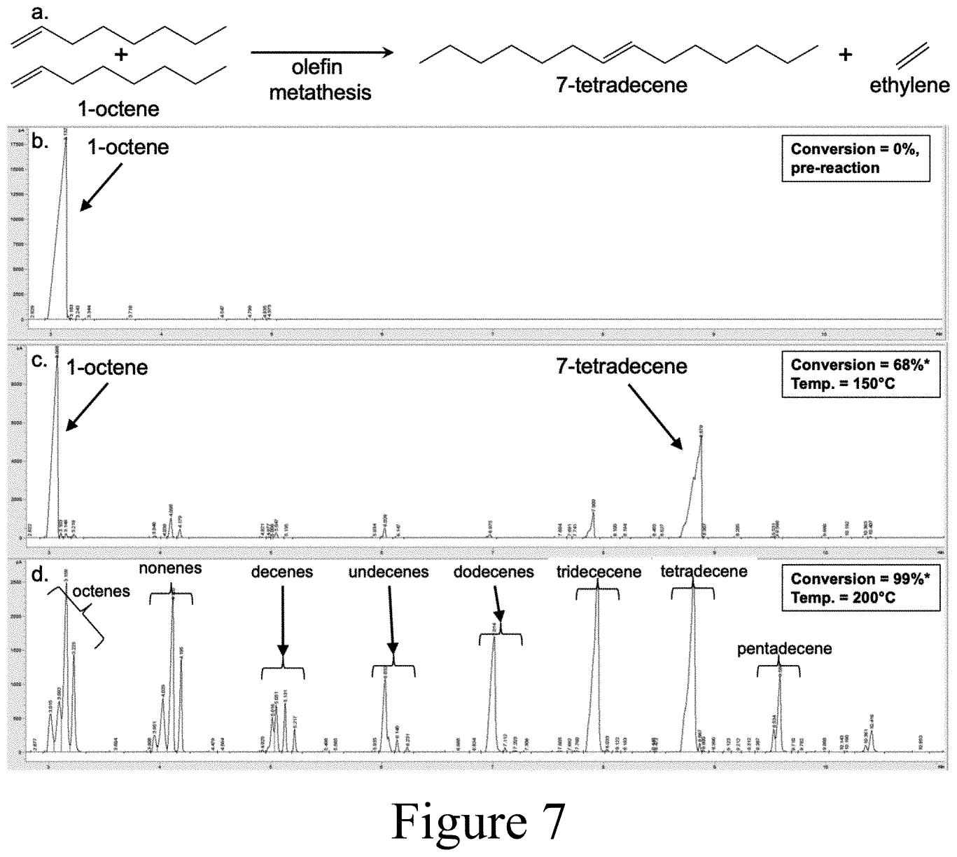

First studied was a pretreatment process for preparing the olefin metathesis catalyst for performance testing in 75 mL batch reactors using the coupling of 1-octene to 7-tetradecene as a model reaction (see FIGS. 6 and 7). After developing the catalyst pretreatment system, the ideal temperature range for TDOCM was evaluated using the alkane rearrangement of 5% (g/g) n-eicosane (n-C₂₀H₄₂) in n-pentane with a 1:1 physical mixture of 8% Re/γ-Al₂O₃ (referred to hereafter as Re₂O₇/γ-Al₂O₃) and 1.7% Sn and 0.8% Pt/γ-Al₂O₃ (referred to hereafter as SnPt/γ-Al₂O₃); these experiments demonstrated that a temperature of about 200° C. provided the highest conversion in the temperature range studied (see FIG. 2).

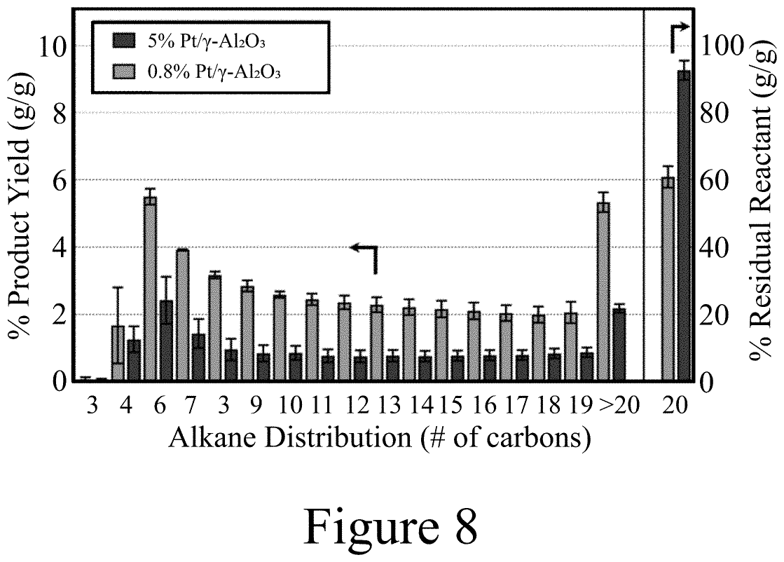

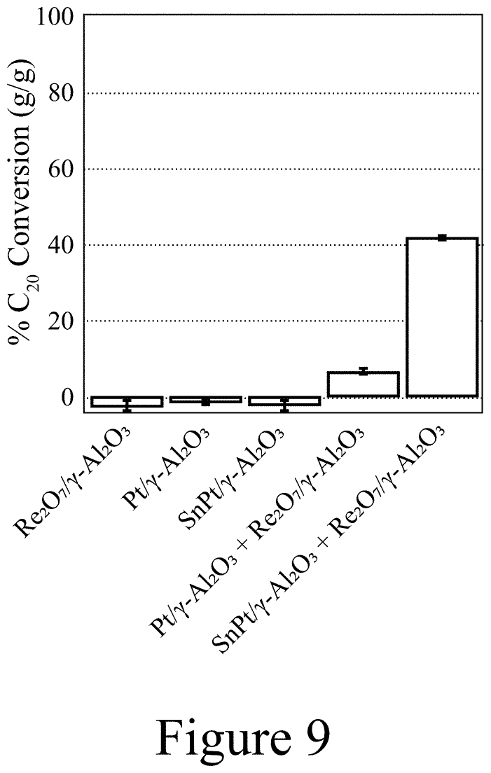

Next, the activity of a 1:1 physical mixture of Re₂O₇/γ-Al₂O₃ and commercially available 5% Pt/γ-Al₂O₃ (referred to as Pt/γ-Al₂O₃ for simplicity) were evaluated. After about 15 hours at about 200° C., the system with Pt/γ-Al₂O₃ provided a n-eicosane conversion of 6.3%±0.8%, generating a product distribution centered around the solvent, n-pentane. The products from this reaction are a distribution of linear alkanes from C3 to C35 with the most prevalent being n-hexane, n-heptane, and n-butane, respectively. The 1:1 physical mixture of Re₂O₇/γ-Al₂O₃ and SnPt/γ-Al₂O₃ demonstrated a significant improvement in activity with a conversion of 41.6%±0.4% under identical conditions. The reaction products from the SnPt/γ-Al₂O₃ system exhibited a similar distribution in product selectivity to the Pt/γ-Al₂O₃ system, again centered around n-pentane, with the most prevalent measured products being n-hexane, n-heptane, and n-butane, respectively. Notably, the SnPt/γ-Al₂O₃ catalyst exhibited a reactive surface area that was 48% that of Pt/γ-Al₂O₃ (see Table 2), suggesting a nearly 14-fold higher rate of n-eicosane disappearance per reactive surface area compared to the system with Pt/γ-Al₂O₃ catalyst. Tin can act as a dehydrogenation promoter for Pt, due, in part, to reduced overall deactivation rates. However, comparing the 5% Pt/γ-Al₂O₃ to a synthesized Pt/γ-Al₂O₃ of similar Pt loading and using the same γ-Al₂O₃ support as the SnPt/γ-Al₂O₃, in a 1:1 physical mixture with Re₂O₇/γ-Al₂O₃, resulted in an n-eicosane conversion of 39.1%±3.0% at identical reaction conditions (see FIG. 8). This suggests the ensemble effect of the SnPt/γ-Al₂O₃ may not play as significant a role as other effects, such as particle size. Control reactions using Pt/γ-Al₂O₃, Re₂O₇/γ-Al₂O₃, or SnPt/γ-Al₂O₃ alone in the conversion of 5% (g/g) neicosane in n-pentane exhibited no measurable activity (see FIG. 9).

TABLE 2
BET surface area, chemisorption area, and elemental analysis of
the catalysts used in this study. Post reaction catalysts were
isolated after 15 hour reaction at 200° C. with n-pentane only.

| | BET | CO | | | |
|---|---|---|---|---|---|
| | Surface | Monolayer | Elemental Analysis | | |
| | Area | Uptake | Pt | Re | Sn |
| Catalyst | m²/g | μmol/g | % (g/g) | % (g/g) | % (g/g) |
| Re₂O₇/γ-Al₂O₃ | 194.9 | 0.4 | 0.1% | 9.5% | 0.0% |
| 5% Pt/γ-Al₂O₃ | 94.5 | 82.0 | 5.7% | 0.0% | 0.0% |
| 0.8% Pt/γ-Al₂O₃ | 206.0 | 21.3 | 0.8% | 0.0% | 0.0% |
| SnPt/γ-Al₂O₃ | 192.5 | 39.7 | 0.9% | 0.0% | 2.0% |
| Re₂O₇ on SnPt/γ-Al₂O₃ | 143.5 | 50.2 | 0.8% | 7.9% | 1.4% |
| SnPt on Re₂O₇/γ-Al₂O₃ | 145.3 | 55.5 | 0.9% | 7.7% | 1.5% |
| 1:1 mixture of SnPt/γ-Al₂O₃ & | — | 10.2 | 0.3% | 3.0% | 0.6% |
| Re₂O₇/γ-Al₂O₃ post-reaction | | | | | |

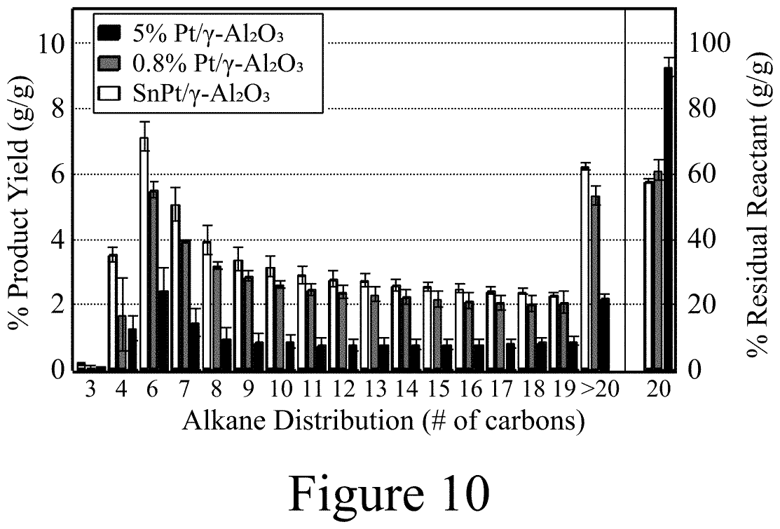

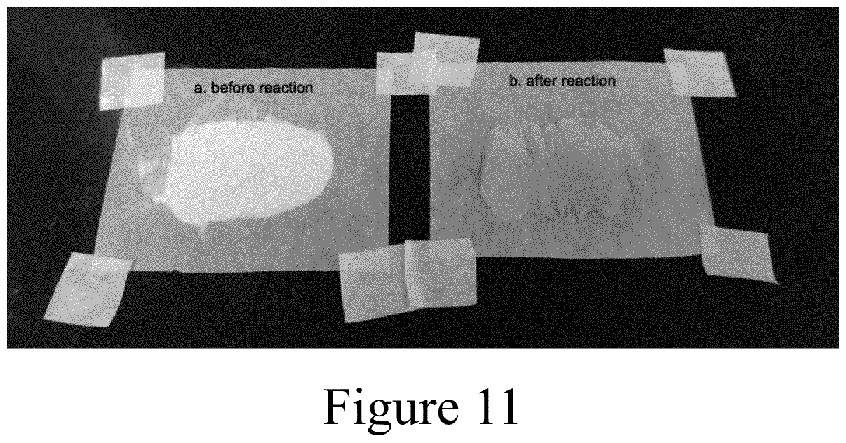

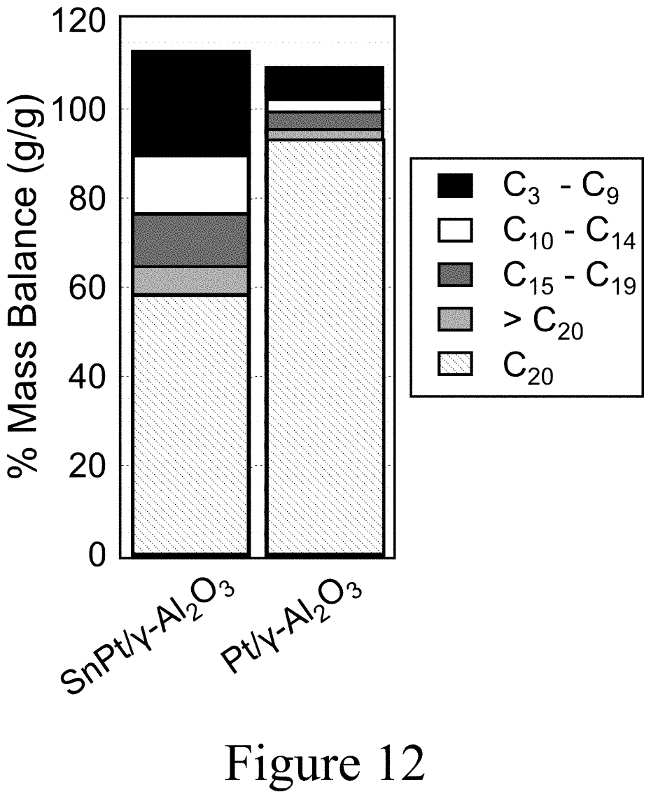

The TDOCM reaction for the alkane rearrangement of 5 wt. % n-eicosane (C₂₀) in n-pentane was evaluated when changing the dehydrogenation catalyst between, 500 mg of 0.8% Pt 1.7% Sn/γ-Al₂O₃, 500 mg of 5% Pt/γ-Al₂O₃, or 500 mg of 0.8% Pt/γ-Al₂O₃ (using a nitrogen precursor), paired with 500 mg of 10% Re₂O₇/γ-Al₂O₃ as the olefin metathesis catalyst, run at 200° C. for 15 hours. Data is presented as the average of duplicates with error bars representing +/− half of the range. The n-pentane and 5% (g/g) n-eicosane with SnPt/γ-Al₂O₃ and Re₂O₇/γ-Al₂O₃ at 200° C. catalyst system deactivated after 15 hours (see FIG. 10) after approximately 225 turnovers (based on the number of dehydrogenation sites). Dehydrogenation catalysts can deactivate over time partly due to formation of carbonaceous deposits, and nonoxidative dehydrogenation often utilizes unit operations for catalyst regeneration with oxygen and halides (e.g., Cl), to remove coke and prevent sintering. The postreaction catalyst was significantly darker in color as compared to the starting material (see FIG. 11) and showed a 49% reduction in reactive surface area (on a dehydrogenation catalyst basis) compared with the fresh catalyst (see Table 2 above), suggesting carbonaceous deposits did reduce the available active surface area. Additionally, it is also possible that the active sites of the rhenium olefin metathesis catalyst deactivate because this catalyst can decompose over time as well. Regardless, the total recovered linear alkane products was greater than the consumed n-eicosane reactant (see FIG. 10), which is feasible, because, as stated above, the solvent is a reactant in this chemistry. Thus, a mass balance of products and residual reactants was greater than unity because some of the carbon from the products originated from the solvent. A total carbon balance was measured from the starting n-eicosane of 110% and 113% for the system with Pt/γ-Al₂O₃ or SnPt/γ-Al₂O₃, respectively (see FIG. 12). This highlights a challenge in this chemistry, namely, to design a catalyst system that favors cross reactions of the reactant and solvent over reactant/reactant or solvent/solvent reactions.

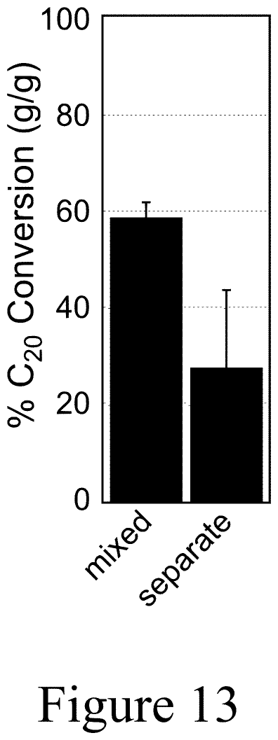

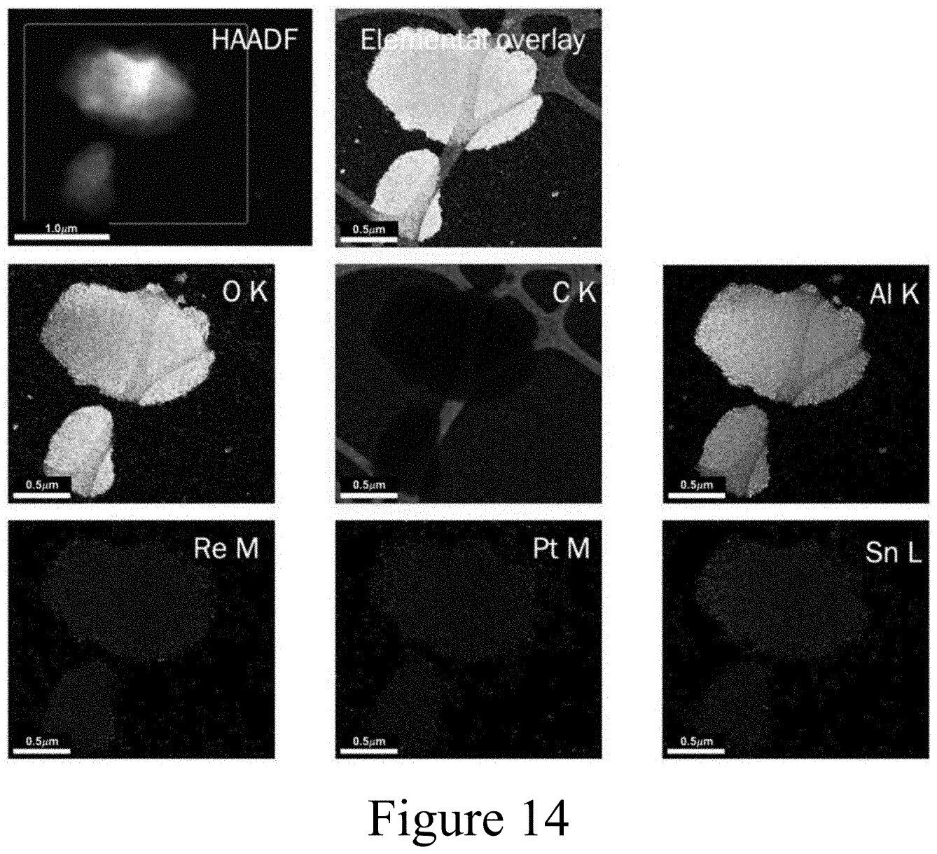

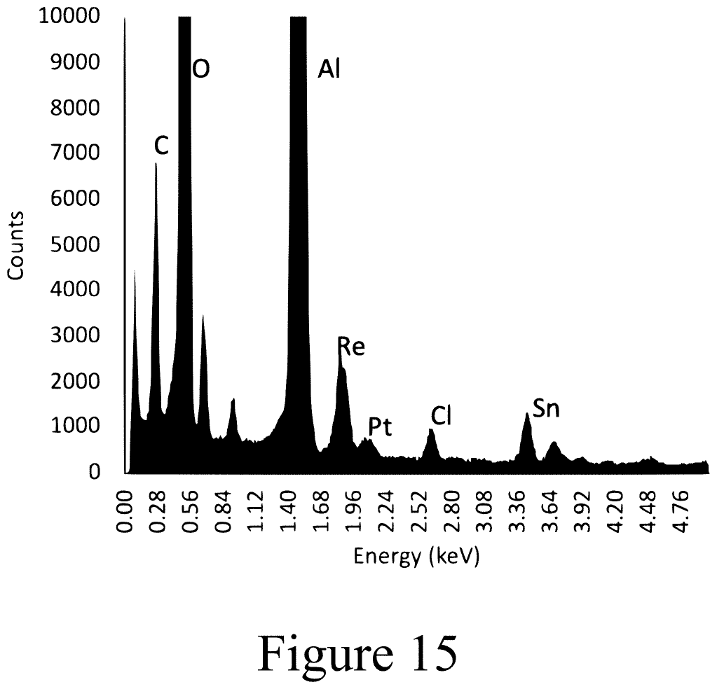

Catalysts before and after pretreatment were also studied. Interestingly, it was observed that the catalysts that were physically mixed before pretreatment demonstrated more than double the n-eicosane alkane rearrangement activity compared to the catalysts that were physically separated during pretreatment (see FIG. 13). To gain insights into this observation, a scanning transmission electron microscopy with energy dispersive x-ray spectroscopy (STEM-EDS) was used to map the elemental composition of the catalysts pretreated separately or comingled. The catalysts that were separate during pretreatment exhibited the expected elemental composition, such that no Sn or Pt was found on the Re₂O₇/γ-Al₂O₃ catalyst that was pretreated by itself and no Re was found on the SnPt/γ-Al₂O₃. However, when the catalysts were mixed prior to and during pretreatment, six out of eight particles analyzed using STEM-EDS contained all three elements, Sn, Pt, and Re, even though these elements were synthesized on separate supports, and the remaining two out of eight particles contained both Sn and Re (see FIGS. 14 and 15). This finding is not entirely surprising, considering the melting point of bulk Re₂O₇ is 297° C. and the pretreatment was conducted at 500° C. Additionally, Pt may migrate in high temperature oxidation conditions through processes like Ostwald ripening and/or particle migration and coalescence. Because pretreating the catalysts in a mixed state enhanced the activity of n-eicosane rearrangement, and the elements of Pt, Sn, and Re were found on single supports, there could be synergistic activity due to the physical proximity of the two reaction distinct reaction sites, or promotion of catalytic activity with the creation of a newly doped alloy. Further, in the case of dehydrogenation catalysts, rhenium can act as a promoter.

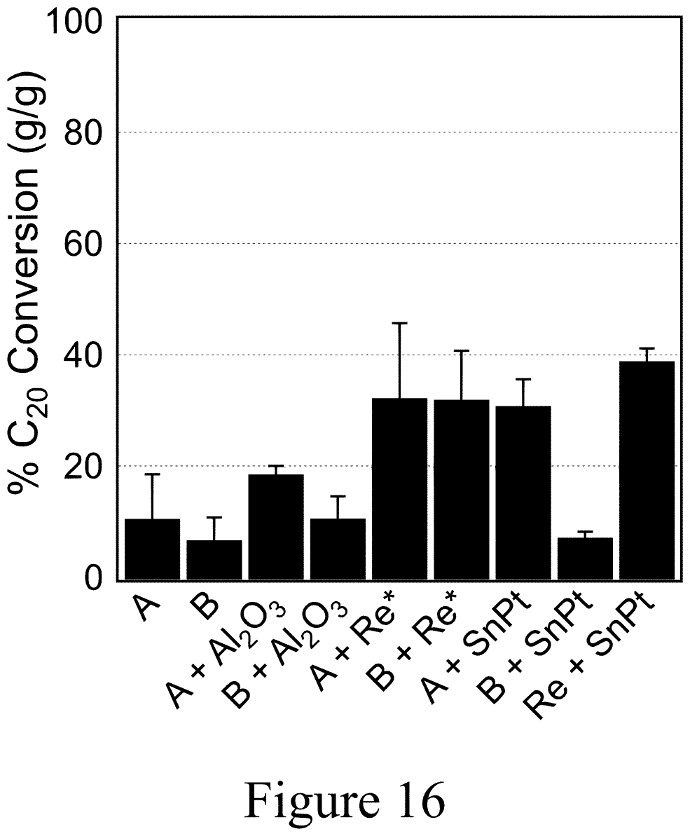

Based on these results, a catalyst with both chemical functionalities on one support was synthesized to determine whether a single supported catalyst could perform as well as a physical mixture of two catalysts. Both Re₂O₇ on SnPt/γ-Al₂O₃ or SnPt on Re₂O₇/γ-Al₂O₃ were synthesized through alternating sequential incipient wetness (i.e., via an initial synthesis of SnPt/γ-Al₂O₃, then via deposition of Re₂O₇ in another round of incipient wetness, or vice versa). Both catalysts exhibited a slight increase in overall dehydrogenation reactive surface area, as compared to the native SnPt, thus the following analysis has roughly equivalent dehydrogenation sites (see Table 2 above). Surprisingly, both catalysts were poor performers, with n-eicosane conversions of 10.8%±8.0% and 7.0%±4.1%, respectively, at about 200° C. in about 15 hours. Both results are significantly lower compared to the 41.6%±0.4% conversion obtained with the physical mixture of Re₂O₇/γ-Al₂O₃ on SnPt/γ-Al₂O₃ (see FIG. 16). The Re olefin metathesis active site can be strongly influenced by the support; thus, Re deposited on bulk Pt or SnPt, as an alloy, would not likely be active in olefin cross metathesis. It can be hypothesized that the formation of alloys with Pt or SnPt reduced the population of active metathesis sites because alloys of PtRe, PtSn, or ReSn (ignoring alkylation). This hypothesis was tested by adding additional γ-Al₂O₃ support, physically mixed with the Re₂O₇ on SnPt/γ-Al₂O₃ or SnPt on Re₂O₇/γ-Al₂O₃, with the expectation that pretreatment would allow for migration of the Re on the catalyst to the new support, forming olefin cross metathesis sites. The additional support increased the neicosane conversion to 18.8%±1.5% and 10.9%±3.9%, respectively. Lastly, Re₂O₇ on SnPt/γ-Al₂O₃ or SnPt on Re₂O₇/γ-Al₂O₃ was supplemented with additional Re₂O₇/γ-Al₂O₃. All cases showed that supplementation by additional Re₂O₇/γ-Al₂O₃ to either Re₂O₇ on SnPt/γ-Al₂O₃ or SnPt on Re₂O₇/γ-Al₂O₃ provided the highest conversion of n-eicosane, within error of a physical mixture of Re₂O₇/γ-Al₂O₃ and SnPt/γ-Al₂O₃. This result implies that the population of olefin metathesis sites is lower on the single support, compared with a physical mixture of the catalysts on two separate supports.

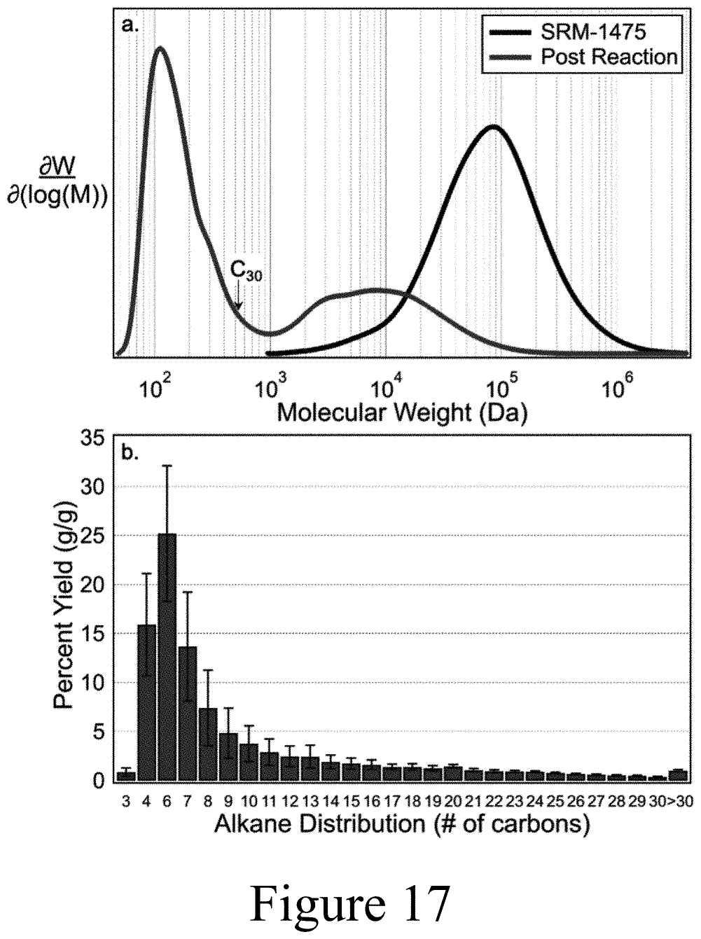

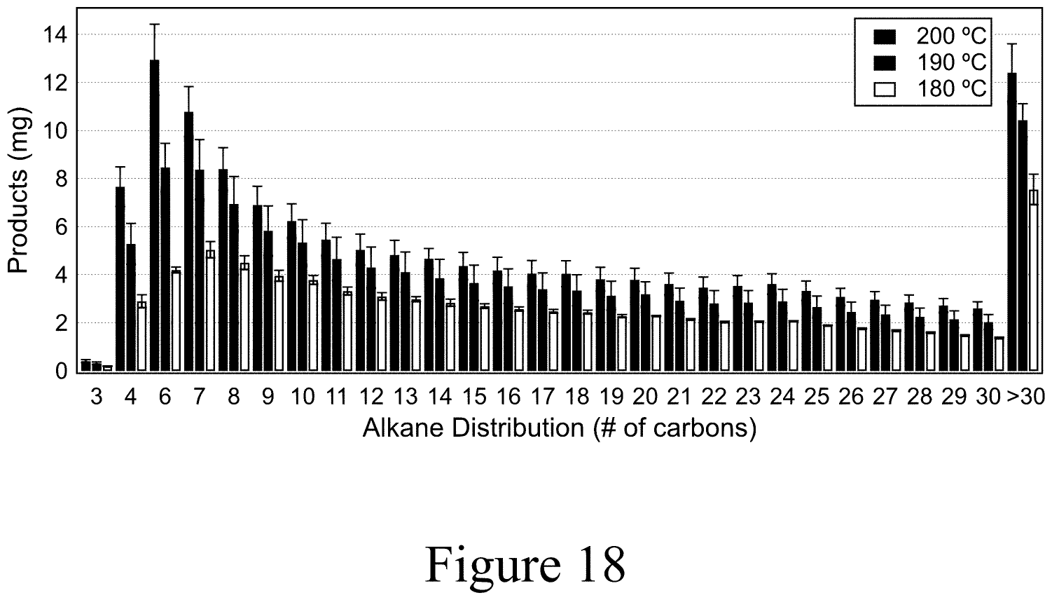

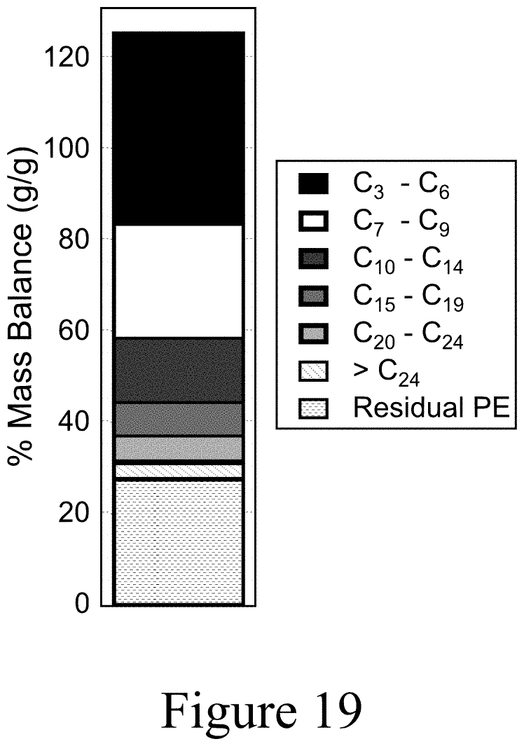

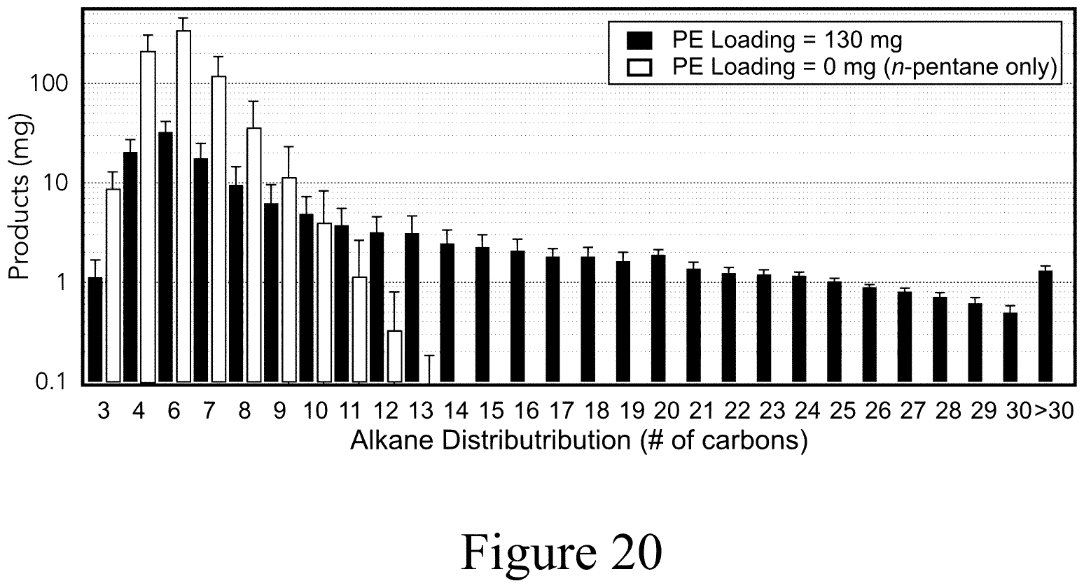

Lastly, the systems described above were utilized to depolymerize a standard reference material (SRM) from the National Institute for Standards and Technology (NIST) for linear PE, SRM-1475. This linear PE feedstock was a standard reference material for high-density PE and has a measured molecular weight of 54.1±2 kDa in our study (see Panels a and b of FIG. 17). First, the effect of reaction temperature on alkane product yield was studied. The highest yield of alkane products occurred at 200° C. (see FIG. 18). Next, three reaction replicates were performed at about 200° C. (see Panels a and b of FIG. 17) and the extent of depolymerization measured using high-temperature gel permeation chromatography. Comparing the molecular weight distribution for the original polymer and the degraded SRM-1475, while ignoring compounds below a molecular weight of 500 Da, a 73% reduction in average molecular weight was obtained. FIG. 17 summarizes the distribution of measured products and the reduction in in the liquid phase from the 130 mg loading of PE was 99%; additionally, the residual polymer had a molecular weight that was 27% of the starting material (see Panel a of FIG. 17), suggesting a carbon balance of 126% (see FIG. 19). In a control reaction with no polymer and only solvent and catalyst present, no alkanes longer than C13 were measured, suggesting larger products are derived from the polymer (see FIG. 20).

Thus, in some embodiments of the present disclosure, a dehydrogenation catalyst for TDOCM may include at least one of chromium oxides, gallium oxides, vanadium oxides, molybdenum oxides, indium oxides, nickel, ruthenium, and/or iridium. In some embodiments of the present disclosure at least one promoter may be used to enhance catalytic activity, including, for example, at least one of lithium, sodium, potassium, rubidium, cesium, and/or gallium. These catalysts may be supported on a variety of supports including, for example, at least one of SiO₂, Al₂O₃—ZrO₂, ZrO₂, CeO₂, MgO, silicalite, K-L, MCM-41, Zn-Beta, Na-Y, SBA-15, and/or ZSM-5. In some embodiments of the present disclosure, a cross metathesis catalyst for TDOCM may include at least one of a heterogeneously supported rhenium, molybdenum, and/or tungsten.

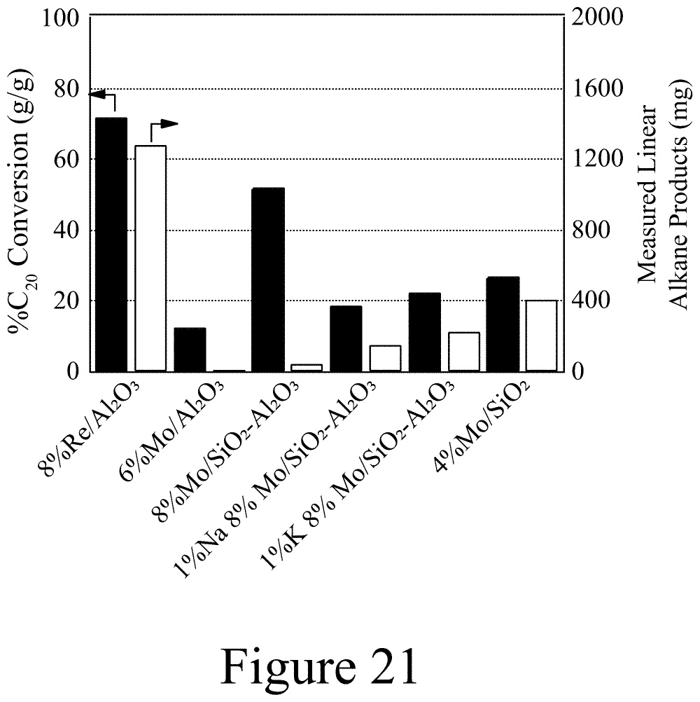

Molybdenum has some advantages as a potential cross metathesis catalyst, for example the absence of volatility issues. Additionally, Mo is ˜100× cheaper as a catalytic metal as compared with Re. We discovered that there are significant support efforts when using Mo. In other words, when using Mo on various supports, a competing reaction, isomerization, begins to impede the efficacy of TDOCM. By changing supports, or doping with an alkali metal, like sodium or potassium, isomerization can be significantly diminished. FIG. 21 illustrates the rate of disappearance of n-eicosane when using Re or Mo based catalysts, demonstrating that SiO₂ is the most efficient support for a Mo-based catalyst, but is still lower in specific activity as compared with a Re catalyst.

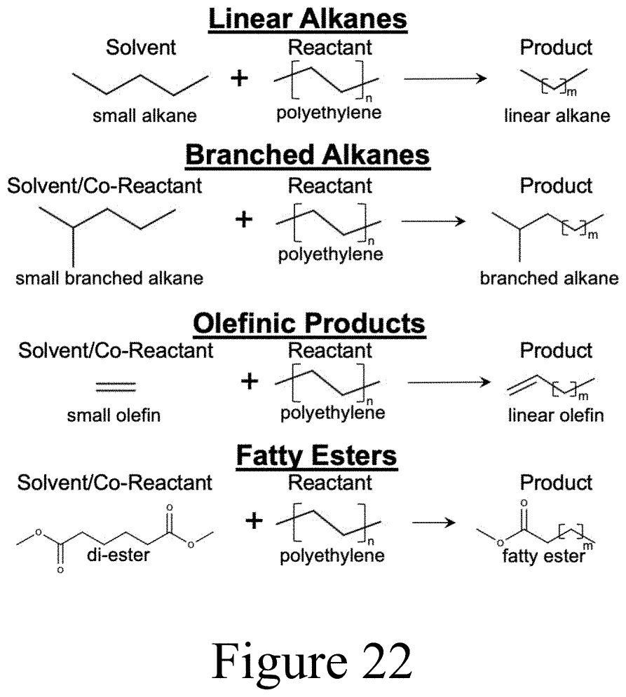

As describe herein, it has been demonstrated in this work that TDOCM can be used to depolymerize polyethylene to a mixture of linear alkane products. However, we believe there are many other products that can be synthesized from this chemistry. As seen in FIG. 22, by changing the solvent, or by adding co-reactants (e.g., ethylene), polyolefin plastics like polyethylene can be converted to branched alkanes, linear alpha olefins (even small olefins like propylene), fatty acids, aromatic surfactants, or many other valuable products. Thus, in some embodiments of the present disclosure the change of a solvent and/or an additional co-reactant may enable the depolymerization of a wide variety of hydrocarbon polymers and/or resins.

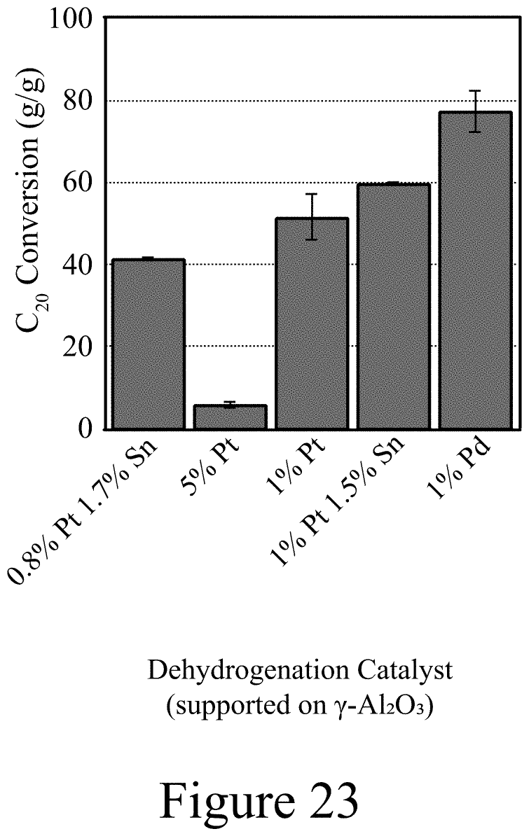

FIG. 23 illustrates catalyst performance when varying the dehydrogenation catalyst (paired with 10% Re2O7/Al2O3) in the consumption of C20. Specifically, FIG. 23 compares catalyst performances in the alkane rearrangement of 5 wt. % n-eicosane (C₂₀) in n-pentane when changing the dehydrogenation catalyst between, 500 mg of 0.8% Pt 1.7% Sn/γ-Al₂O₃, 500 mg of 5% Pt/γ-Al₂O₃, 500 mg of 1% Pt/γ-Al₂O₃ (using a chlorine precursor), 500 mg of 1% Pt 1.5% Sn/γ-Al₂O₃, or 500 mg of 1% Pd/γ-Al₂O₃, paired with 500 mg of 10% Re₂O₇/γ-Al₂O₃ as the olefin metathesis catalyst, run at 200° C. for 15 hours. Data is presented as the average of duplicates with error bars representing +/−½ the range.

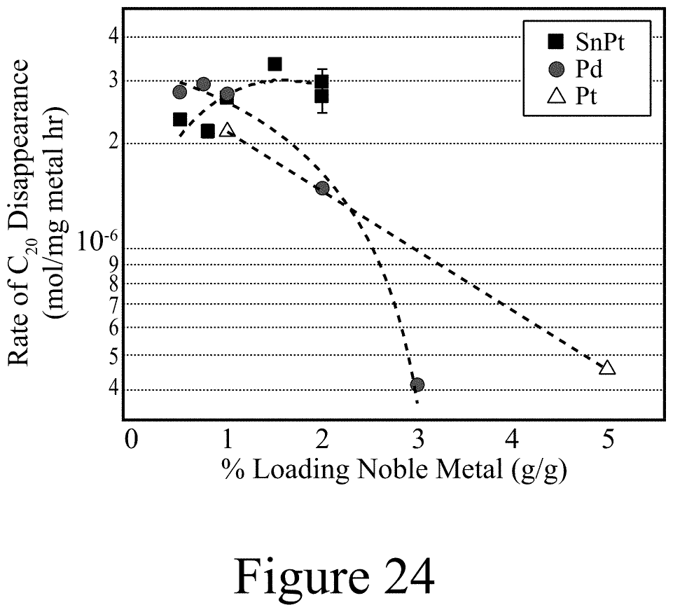

FIG. 24 illustrates the rate of C20 disappearance (similar to the C20 consumption) as a function of three different dehydrogenation metals, Pt, SnPt (bimetallic), or Pd, and a variety of metal loadings (x-axis). Loadings refer to the mass of metal loaded on Al₂O₃, as in, 2% Pd/Al₂O₃. All of these dehydrogenation catalysts were combined with 10% Re₂O₇/Al₂O₃ as the olefin metathesis catalyst. All reactions were run at 200 C for 15 hours.

### Experimental:

Catalyst synthesis: Catalysts were synthesized using incipient wetness on a γ-Al₂O₃ support (CAS: 1344-28-1, Strem Chemicals Inc., Newbury, Mass., USA). Platinum on alumina (Pt/γ-Al₂O₃) at 5% (g/g) loading (Pt basis) was purchased from Sigma Aldrich (MDL: MFCD00011179, St. Louis, Mo., USA). Supported Re₂O₇/γ-Al₂O₃ at an 8% (g/g) loading (Re basis) was synthesized using 75-80% perrhenic acid solution (CAS: 13768-11- 1, Sigma Aldrich, St. Louis, Mo., USA) with deionized (DI) water as the solvent. Supported SnPt/γ-Al₂O₃ with a 1.7% (g/g) Sn and 0.8% (g/g) Pt loading (Sn and Pt basis) utilized a sequential deposition, first 98% tin (II) chloride (CAS: 10025-69-1, Sigma Aldrich, St. Louis, Mo., USA) was dissolved in 200 proof ethanol, mixed with the support, and calcined (temperature profile shown in the Appendix). Subsequently, the material was functionalized with Pt using 99.9% chloroplatinic acid hydrate (CAS: 26023-84-7, Sigma Aldrich, St. Louis, Mo., USA). The 0.8% Pt catalyst was synthesized with platinum nitrate dihydrate (CAS: 32916-07-7, Sigma Aldrich, St. Louis, Mo., USA). All impregnated supports were calcined in air with a temperature profile of 2° C./min from room temperature to 120° C., held for 4 hours, followed by a ramp of 5° C./min to 550° C. and held for 6 hours.

Catalyst performance testing: Reactions were performed on a Series 5000 Multiple Reactor System by Parr Instruments (Moline, Ill., USA), allowing for six 75 mL total volume reactors to be run in parallel with temperature control and magnetic mixing. These reactors were filled with 30 mL of reaction medium (either solvent only in the case of solid substrates or solvent and soluble reactant in the case of n-eicosane). Prior to preparing solutions for reactors, all glassware was dried in 100° C. oven. For the soluble reactant, ˜6.33 g of 99% n-eicosane (CAS: 112-95-8, ACROS Organics, Fair Lawn, N.J., USA) was added to a volumetric flash and brought up to 200 mL with +99%, anhydrous, n-pentane (CAS: 109-66-0, ACROS Organics, Fair Lawn, N.J., USA). This solution was then transferred to a round bottom flask and dried with the addition of 2.0 g of pre-dried molecular sieves, sealed with a rubber stopper and purged with ultra-high purity (UHP) argon. A 30 mL volume was then added to each reactor, while each reactor continuously purged with UHP argon. A sample of this solution was retained as a pre-reaction mixture for determination of conversion. Mass balances of the reactors were performed to track the exact amount of solution added and any losses of n-pentane due to evaporation. Once reactors were prepared with reaction solution, catalysts were then pretreated.

Catalysts were prepared for reaction using a custom pretreatment reactor system (see FIG. 6). Half-inch Swagelok tube fittings were selected with a large steel mass to ensure higher heat capacity during the transition periods of the pretreatment process (see FIG. 6). The tubes were layered sequentially with 300 mg of packed quartz wool, 200 mg of γ-Al₂O₃, the mixed catalyst, 200 mg of γ-Al₂O₃, and covered in perforated aluminum foil. The tubes were then heated in a muffle furnace under atmosphere at a ramp rate of 12° C./min to 500° C. and held for 1 hour. Tubes were then rapidly transferred (in a hot state) to an UHP argon (Airgas, Radnor, Pa., USA) purge system (see FIG. 6). Only three tubes were brought at a time to the UHP argon purge, leaving the other three in the muffle furnace during this transition. The first three tubes were loaded on the purge system, argon flow started, and monitored to ensure adequate flow. Once installed and purging, the last three tubes then went through the same process. Tubes were purged for 15 minutes, until they reached near ambient temperature. Individual reactors were prepared prior to catalyst pretreatment, with solvent, magnetic stir bar, and soluble reactant (i.e., n-eicosane where relevant). A UHP argon gas line was then connected to the head of a Parr reactor and flow initiated. Pretreatment tubes were then removed from the purge apparatus and rapidly evacuated into a Parr reactor, solid substrates (i.e., PE where relevant) was then added, and the reactor was sealed under flowing UHP Argon.

The Series 5000 Multiple Reactor System by Parr Instruments has temperature control with a ˜30 minutes transient heat-up to reach reaction temperature and magnetic mixing. All reported reaction times (e.g., 15 hours) were for total duration from ambient temperature, meaning the first 30 minutes of the reaction is the transient heat up to the desired reaction temperature. Reactors were quenched in an ice bath at the end of reaction testing. Reactors were purged with UHP helium (Airgas, Radnor, Pa., USA) a total of three times prior to initiating temperature control. The third pressurization was used as a leak test to ensure the reactors had an adequate seal. The final pressure was set to 40 bar He prior to heating. We tested whether reaction performance was dependent on helium pressure by running tandem dehydrogenation and olefin cross metathesis (TDOCM) of n-pentane and n-eicosane at 20 bar and 40 bar He. The conversion of 5% (g/g) n-eicosane in n-pentane at 200° C. for 15 hours with a physical mixture of 500 mg Re₂O₇/γ-Al₂O₃ and 500 mg of SnPt/γ-Al₂O₃ at 20 bar He or 40 bar He, was 40.5%±1.7% (g/g) and 41.6%±0.4% (g/g), respectively, where the error was measured as half the range of duplicates. All subsequent reactions were run using 40 bar He. All reaction data were run in reaction duplicate, and the average of two measurements is reported with the error representing ±½ the range, unless otherwise stated.

Post reaction, a well-mixed liquid sample was filtered with a 0.2 μm syringe filter. Liquid samples were analyzed by injection on an Agilent 6890N gas chromatograph with a flame ionization detector (GC-FID) and equipped with a HP-5MS column (30 m×0.250 mm×0.25 μm). Chromatographic separation was achieved using the following GC oven program: 50° C. (hold one minute), 15° C./min to 180° C. (hold 1 minutes), ramp 20° C./min to 325° C. (hold 6 minutes). A one mL volume was injected into the inlet, which was set to 300° C. UHP helium (Airgas, Radnor, Pa., USA) was used as the carrier gas for the system. An alkane standard mixture of linear alkanes from C₈-C₄₀ (AccuStandard, New Haven, Conn., Part number: PS-CP-06A-1ML) was used for quantification of products. Internal standard calibration curves were generated by diluting the standard mix with n-pentane and spiking with mesitylene (CAS: 108-67-8, ACROS Organics, Fair Lawn, N.J., USA) as the internal standard. A n-heptane (CAS: 142-82-5, ACROS Organics, Fair Lawn, N.J., USA) calibration curve was generated, in-house, in n-pentane (CAS: 109-66-0, ACROS Organics, Fair Lawn, N.J., USA). All other compounds utilized effective carbon number to determine a response factor. Conversion of n-eicosane was determined by first using the concentration of n-eicosane determined in the pre-reaction solution and the mass of solution added to each reactor, to calculate the initial mass of n-eicosane, and the final mass of each solution with the concentration determined via GC. Thus, conversion was defined as=(C₂₀^{Initial}−C₂₀^{Final})/C₂₀^{Initial}, where C₂₀^{Initial}=the original mass of n-eicosane in the reactor and C₂₀^{Final} was the final mass of n-eicosane in the reactor.

To determine the molecular weight distribution for residual PE, samples consisting of the residual polymer and catalyst mixture from the reactor were first allowed to dry at ambient conditions to remove low volatility liquids. An approximately 250 mg sample of the recovered solid (catalyst and residual PE) was then enclosed in packets of stainless steel (filtering) mesh and placed into 10 mL of 1,2,4-trichlorobenzene with 300 ppm (mg/kg) Irganox 1010 (CAS: 6683-19-8, BASF—North America, Florham, N.J., USA) as an antioxidant. The samples were heated with the solvent for 2 hours at 145° C. The mesh packets were removed, and the solutions were then transferred to the appropriate chromatography vials for analysis. This recovered sample and aliquots of NIST SRM-1475A,1 a linear PE substrate (certified Mw=52,000 g/mol±2,000 g/mol), were analyzed by high temperature size exclusion chromatography (HT-SEC) using a Tosoh HT-EcoSEC instrument (Tosoh—North America, Grove City, Ohio) with differential refractive index (RI) detection. Separations were conducted at 135° C. using 1,2,4-trichlorobenzene (CAS: 120-82-1, Sigma Aldrich, St. Louis, Mo., USA) as the eluent, with 300 mg/kg Irganox 1010 added as antioxidant to the solvent reservoir. Five μL of dodecane (CAS: 112-40-3, Sigma Aldrich, St. Louis, Mo., USA) was added to each vial as a flow rate marker. The stationary phase was a set of 3 Tosoh HT columns (2 Tosoh TSKgel GMHHR-H (S) HT2, 13 μm mixed bed, 7.8 mm ID×30 cm columns and 1 Tosoh TSKgel GMHHR-H (20) HT2, 20 μm, 7.8 mm ID×30 cm column with an exclusion limit≈4×108 g/mol). For the Tosoh instrument, narrow dispersity polystyrene standards were used for calibration and were converted to the PE equivalent using Mark-Houwink parameters for polystyrene and PE. The uncertainty in the molar masses obtained by this measurement is ±1.5%. All injections were done at least three times, and the reported error on all measurements is one standard deviation of the mean.

Catalyst characterization: The elemental content of the catalysts was analyzed via inductively coupled plasma—optical emission spectrometry (ICP-OES) (Agilent 5110 ICP-OES, Agilent Technologies, Santa Clara, Calif., USA). Initially, approximately 25 mg of each catalyst was weighed out and dissolved in 10 mL of concentrated acid mixture (HNO₃ for Re₂O₇/γ-Al₂O₃ or 3:1 HNO₃:HCl for Pt/γ-Al₂O₃ and SnPt/γ-Al₂O₃. This mixture was heated in a Teflon vessel at 200° C. for 30 minutes in a microwave digestion system (CEM MARS5) operating at 1600 W. The digestate was filtered and diluted to 50 mL with DI water. A 5 mL aliquot of this solution was then combined with an additional 10 mL of the corresponding concentrated acid mixture and diluted again to 50 mL with DI water to produce a sample solution with appropriate concentrations and consistent sample matrix for ICP-OES analysis. Calibration standards of the relevant elements (Al, Pt, Re, Sn) were made at 1, 5, 10, 20, and 40 ppm in the same dilute acid matrix. Elemental concentrations were quantified after ICPOES analysis using the following characteristic emission peaks: 396.152 nm (Al), 214.424 nm (Pt), 221.427 nm (Re), 235.485 nm (Sn).

Surface area was measured with nitrogen adsorption using the multipoint Brunauer-Emmett-Teller (BET) method performed with a Quantichrome Instruments (Boynton Beach, Fla., USA) Quadrasorb. Approximately 0.1 g sample was degassed in UHP He at 200° C. for 16 hours, then allowed to cool to ambient prior to collecting an adsorption and desorption isotherm at 77K with a 30% N₂ balance He carrier gas.

The active metal surfaces of the samples were probed with CO chemisorption on an Autosorb-1 by Quantichrome Instruments (Boynton Beach, Fla., USA). Approximately 0.1 g of sample was packed with quartz wool into the sample tube. The sample was initially heated to 150° C. under N₂ and held at temperature for 60 minutes. The flow was then changed to H₂ and the sample was heated to 200° C. and held at temperature for 120 minutes. The sample tube was then evacuated for 120 minutes, after which the furnace was cooled to the analysis temperature. Analysis was conducted under CO at 40° C. with a 16-point analysis and a one-minute thermal equilibration time.

Scanning transmission electron microscopy (STEM) was performed by first dispersing the catalyst particles onto ultrathin carbon film on lacey carbon support film transmission electron microscopy (TEM) grids purchased from Ted Pella (Redding, Calif., USA). The TEM samples were examined in a Field Electron and Ion Company (FEI, Hillsboro, Oreg., USA) Tecnai F20 UltraTwin field-emitting-gun (FEG) scanning transmission electron microscope (STEM) operated at 200 kV. Energy dispersive X-ray spectroscopy (EDS) was performed using an EDAX (Mahwah, N.J., USA) Octane T Optima windowless Si drift detector (SDD) EDS system and processed using EDAX TEAM software.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising a dehydrogenation (D) catalyst and a cross metathesis (CM) catalyst, wherein both are positioned on a support.

2. The composition of claim 1, wherein the D catalyst comprises at least one of tin, platinum, palladium, nickel, ruthenium, iridium, a chromium oxide, a gallium oxide, a vanadium oxide, a molybdenum oxide, or an indium oxide.

3. The composition of claim 1, wherein the CM catalyst comprises at least one of rhenium, molybdenum, or tungsten.

4. The composition of claim 1, wherein the support comprises at least one of a metal oxide, silicalite, or a zeolite.

5. The composition of claim 4, wherein the metal oxide comprises at least one of Al₂O₃, SiO₂, ZrO₂, CeO₂, MgO, or ZnO₂.

6. The composition of claim 4, wherein the zeolite comprises at least oner of KL, MCM-41, a beta type, a zeolite Y, SBA-15, or ZSM-5.

7. The composition of claim 1, wherein the D catalyst comprises platinum and tin, the CM catalyst comprises rhenium, and the support comprises Al₂O₃.

8. The composition of claim 1, further comprising a promoter.

9. The composition of claim 8, wherein the promoter comprises at least one of lithium, sodium, potassium, rubidium, cesium, or gallium.

10. The composition of claim 1, wherein:
the support comprises a first portion and a second portion,
the D catalyst is positioned on the first portion at a first concentration,
the D catalyst is positioned on the second portion at a second concentration that is less than the first concentration,
the CM catalyst is positioned on the first portion at a third concentration that is less than the first concentration, and
the CM catalyst is positioned on the second portion at a fourth concentration that is greater than the third concentration and greater than second concentration.

11. The composition of claim 10, wherein the first concentration is between about 0.1 wt % and about 15 wt %.

12. The composition of claim 10, wherein the second concentration is between about 0.1 wt % and about 20 wt %.

13. The composition of claim 1, further comprising HCl positioned on the support.

14. A method comprising:
contacting a mixture comprising a first hydrocarbon and a second hydrocarbon with a composition, wherein:
the first hydrocarbon has a first molecular weight,
the second hydrocarbon has a second molecular weight,
the first molecular weight is larger than the second molecular weight,
the contacting results in a decrease of the first molecular weight to a third molecular weight, and
the composition comprises:
a dehydrogenation (D) catalyst and a cross metathesis (CM) catalyst,
wherein both catalysts are positioned on a support.

15. The method of claim 14, wherein the contacting is performed at a temperature between about 120° C. and about 400° C.

16. The method of claim 14, wherein the contacting is performed at a pressure between about 1 bar and about 40 bar.

17. The method of claim 14, wherein the contacting is performed with the first hydrocarbon and the second hydrocarbon in a gas phase.

18. The method of claim 14 wherein the first molecular weight is between about 30 Da and about 300 kDa.

19. The method of claim 14 wherein the second molecular weight is between about 1 kDa and about 100 kDa.

20. The method of claim 14 wherein the third molecular weight is between about 30 kDa and about 60 kDa.

21. The method of claim 14, wherein the first hydrocarbon comprises at least one of a high density polyethylene (PE), a medium density PE, a low density PE, a linear low density PE, polypropylene, or polysytrene.

22. A method comprising:
a first synthesizing of a first solid comprising a first catalyst on a first substrate;
a second synthesizing of a second solid comprising a second catalyst on a second substrate;
combining the first solid with the second solid resulting in a mixture; and
heating the mixture to temperature between about 120° C. and about 400° C., wherein:
the heating results in a portion of the first catalyst transferring from the first solid to the second solid,
the heating results in a portion of the second catalyst transferring from the second solid to the first solid,
a first concentration of the first catalyst on the first solid is higher than a second concentration of the first catalyst on the second solid, and
a third concentration of the second catalyst on the second solid is higher than a fourth concentration of the second catalyst on the first solid.
